(19) United States
(12) Patent Application Publication
(10) Pub. No.: US 2026/0093049 A1
(43) Pub. Date: Apr. 2, 2026

(54) DUAL-ENDED READOUT POSITRON EMISSION TOMOGRAPHY DETECTORS, METHODS FOR DETERMINING PHOTON INFORMATION, AND POSITRON EMISSION COMPUTED TOMOGRAPHY IMAGING DEVICES

(71) Applicant: SHANGHAI UNITED IMAGING HEALTHCARE CO., LTD., Shanghai (CN)

(72) Inventors: Zhenrui LU, Shanghai (CN); Longpeng LIU, Wuhan (CN); Hongfeng WANG, Wuhan (CN); Zhenjie HAN, Shanghai (CN); Dongdong BI, Shanghai (CN); Shaohui AN, Shanghai (CN)

(73) Assignee: SHANGHAI UNITED IMAGING HEALTHCARE CO., LTD., Shanghai (CN)

(21) Appl. No.: 19/344,493

(22) Filed: Sep. 29, 2025

(30) Foreign Application Priority Data
Sep. 29, 2024 (CN) 202411379312.8

(51) Int. Cl. G01T 1/202; G01T 1/29

(52) U.S. Cl. CPC G01T 1/202; G01T 1/2985

(57) ABSTRACT

A dual-ended readout positron emission tomography (PET) detector, a method for determining photon information, and a PET imaging device are provided. The dual-ended readout PET detector includes a crystal array, a first processing unit, and a second processing unit. The crystal array includes a plurality of crystal units. The first processing unit is disposed at a first end of the crystal array. The second processing unit is disposed at a second end of the crystal array, and the first end and the second end are disposed opposite to each other. Each of the plurality of crystal units includes a side surface between the first end and the second end, and the side surfaces of at least two of the plurality of crystal units have different optical conductivities.

### CROSS-REFERENCE TO RELATED APPLICATION

The present application claims priority to Chinese Patent Application No. 202411379312.8, filed on Sep. 29, 2024, the entire contents of which are hereby incorporated by reference.

### TECHNICAL FIELD

The present disclosure relates to the field of medical technology, and more particularly, to a positron emission tomography (PET) detector, a method for determining photon information, and a PET imaging device.

### BACKGROUND

Taking a PET medical scanning device as an example, to obtain high system spatial resolution, a detector of the PET device typically employs a crystal array structure. The smaller a pixel cross-section of a crystal unit in the crystal array, the better an intrinsic resolution of the detector. However, for an event obliquely incident on a crystal unit, if the depth of interaction within the crystal unit cannot be effectively distinguished, a parallax effect may occur. The parallax effect may lead to a gradual reduction in the resolution capability of the detector for events deviating from the center of the field of view, causing image distortion and quantitative analysis errors, and ultimately affecting the accurate judgment of lesion properties and the evaluation of treatment effects. Furthermore, a current trend in mainstream detectors is toward a high-sensitivity design with long crystals and a long axial field of view, which further amplifies an influence of the parallax effect.

A detector of a current medical scanning device is typically provided with a pair of photoelectric components of equal scale at both ends of the crystal array. Compared to a manner of placing photoelectric components at a single end, this configuration allows photons generated by a gamma-ray response to be captured at both ends within a shorter optical path, thereby efficiently obtaining depth of interaction (DOI) information of the photons. However, this type of detector has a problem of high hardware costs.

Therefore, it is desirable to provide a dual-ended readout PET detector, a method for determining photon information, and a PET imaging device, so that photons generated by a gamma-ray response can be captured at both ends within a shorter optical path, thereby efficiently obtaining response depth information of the photons.

### SUMMARY

An aspect of the present disclosure provides a dual-ended readout positron emission tomography (PET) detector. The dual-ended readout PET detector includes a plurality of crystal units. The first processing unit is disposed at a first end of the crystal array. The second processing unit is disposed at a second end of the crystal array, and the first end and the second end arc disposed opposite to each other. Each of the plurality of crystal units includes a side surface between the first end and the second end, and the side surfaces of at least two of the plurality of crystal units have different optical conductivities.

An aspect of the present disclosure provides a method for determining photon information. The method is implemented on a dual-ended readout PET detector. The dual-ended readout PET detector comprising a crystal array, a first processing unit disposed at a first end of the crystal array, and a second processing unit disposed at a second end of the crystal array. The method includes: determining, based on first photon information of first scintillation photons that are emitted from the first end and collected by the first processing unit, 2D position information and first energy information of the first scintillation photons; determining, based on second photon information of second scintillation photons that are emitted from the second end and collected by the second processing unit, second energy information of the second photons; and determining response depth information based on the first energy information and the second energy information.

An aspect of the present disclosure provides a PET imaging device. The PET imaging device includes a plurality of dual-ended readout PET detector each of which includes a crystal array, a first processing unit, and a second processing unit. The crystal array includes a plurality of crystal units. The first processing unit is disposed at a first end of the crystal array. The second processing unit is disposed at a second end of the crystal array, and the first end and the second end are disposed opposite to each other. Each of the plurality of crystal units includes a side surface between the first end and the second end, and the side surfaces of at least two of the plurality of crystal units have different optical conductivities. The plurality of dual-ended readout PET detectors are arranged around an axis to form a detection ring, and along a radial direction of the detection ring, the second processing units of the plurality of dual-ended readout PET detectors are closer to the axis than the first processing units of the plurality of dual-ended readout PET detectors.

### BRIEF DESCRIPTION OF THE DRAWINGS

The present disclosure is further illustrated in terms of exemplary embodiments. These exemplary embodiments are described in detail with reference to the drawings. These embodiments are non-limiting exemplary embodiments, in which like reference numerals represent similar structures, and wherein:

FIG. 1 is a schematic diagram illustrating a structure of an exemplary detection device in the related art;

FIG. 2 is a first schematic diagram illustrating a structure of an exemplary dual-ended readout PET detector of a medical scanning device according to some embodiments of the present disclosure;

FIG. 3 is a second schematic diagram illustrating a structure of an exemplary dual-ended readout PET detector of a medical scanning device according to some embodiments of the present disclosure;

FIGS. 4(a)-4(c) are schematic diagrams illustrating an attachment of an exemplary light-splitting structure according to some embodiments of the present disclosure;

FIG. 5(a) is a third schematic diagram illustrating a structure of an exemplary dual-ended readout PET detector of a medical scanning device according to some embodiments of the present disclosure;

FIG. 5(b) is a fourth schematic diagram illustrating a structure of an exemplary dual-ended readout PET detector of a medical scanning device according to some embodiments of the present disclosure.

FIGS. 6(a)-6(c) are schematic comparison diagrams of exemplary detection rings according to some embodiments of the present disclosure;

FIG. 7 is a schematic diagram illustrating an application scenario of an exemplary system for determining photon information according to some embodiments of the present disclosure;

FIG. 8 is a schematic diagram illustrating an exemplary structure of a computer device according to some embodiments of the present disclosure;

FIG. 9 is a flowchart of an exemplary process for determining photon information according to some embodiments of the present disclosure;

FIG. 10 is a schematic diagram illustrating a structure of an exemplary dual-ended readout PET detector of a medical scanning device according to some other embodiments of the present disclosure; and

FIG. 11 is a schematic diagram illustrating a process for determining photon information according to some embodiments of the present disclosure.

### DETAILED DESCRIPTION

In order to more clearly illustrate the technical solutions related to the embodiments of the present disclosure, a brief introduction of the drawings referred to the description of the embodiments is provided below. Obviously, the drawings described below are only some examples or embodiments of the present disclosure. Those having ordinary skills in the art, without further creative efforts, may apply the present disclosure to other similar scenarios according to these drawings. Unless obviously obtained from the context or the context illustrates otherwise, the same numeral in the drawings refers to the same structure or operation.

It should be understood that “system,” “device,” “unit,” and/or “module” as used herein is a manner used to distinguish different components, elements, parts, sections, or assemblies at different levels. However, if other words serve the same purpose, the words may be replaced by other expressions.

As shown in the present disclosure and claims, the words “one,” “a,” “a kind,” and/or “the” are not especially singular but may include the plural unless the context expressly suggests otherwise. In general, the terms “comprise,” “comprises,” “comprising,” “include,” “includes,” and/or “including” merely prompt to include operations and elements that have been clearly identified, and these operations and elements do not constitute an exclusive listing. The methods or devices may also include other operations or elements.

Flowcharts are used in the present disclosure to illustrate operations performed by a system according to embodiments of the present disclosure. It should be understood that preceding or succeeding operations are not necessarily executed in a precise order. Instead, various steps may be processed in a reverse order or simultaneously. At the same time, other operations may be added to these processes, or one or more steps may be removed from these processes.

Taking a positron emission computed tomography (PET) device as an example, to obtain high system spatial resolution capability, a detector of the PET device usually adopts a structural design of a crystal array. A smaller a pixel cross-section of a crystal unit in the crystal array leads to better intrinsic resolution capability of the detector. However, for an event (e.g., a coincidence event) obliquely incident on a crystal unit, if a depth of interaction within the crystal unit cannot be effectively distinguished, a parallax effect may occur. The parallax effect may lead to a gradual reduction in the resolution capability of the detector for events deviating from the center of the field of view, causing image distortion and quantitative analysis errors, and ultimately affecting the accurate judgment of lesion properties and the evaluation of treatment effects. For small-aperture detectors dedicated to animal imaging and local imaging, since an imaging object usually fills an entire field of view, a large count of valid events may be located at edges of the field of view, which also further exacerbates the parallax effect.

In addition, to improve an overall sensitivity of a system, a current trend in mainstream detectors is toward a high-sensitivity design with long crystals and a long axial field of view. A crystal unit with a long axial length may further amplify an influence of the parallax effect. Therefore, a PET detector with a depth of interaction (DOI) capability has become a research hotspot for a new generation of high-performance detectors.

Currently, detectors for PET include a detector structure with single-end photoelectric component readout (hereinafter referred to as the single-end structure), a detector structure with dual-end photoelectric component readout (hereinafter referred to as the dual-end structure), and a detector structure with multi-end photoelectric component readout (hereinafter referred to as the multi-end readout). The single-end structure refers to collecting photon energy at a single light emitting surface of the crystal array. The dual-end structure refers to simultaneously collecting photon energy at both an upper and a lower light emitting surface of the crystal array. The multi-end structure refers to simultaneously collecting photon energy at a plurality of light emitting surfaces of the crystal array.

The single-end structure includes a multi-fluorescent material layered structure (Phoswich structure), a cross-matrix stacked structure (Stacked Matrices structure), a U-shaped bridge structure (U-shaped structure), a prism bridge structure (Prism structure), a phosphor-coated structure, a differentiated built-in light-splitting structure, a side-readout structure, a continuous crystal structure (Monolithic structure), and a semi-continuous crystal structure (Semi-Monolithic structure).

The Phoswich structure uses a plurality of layers of crystals made of different materials or with different compositions stacked together, and achieves depth discrimination of corresponding crystal layers by utilizing differences in light emission rise time, light emission decay, or the like between different materials. The Stacked Matrices structure uses a plurality of layers of crystals made of the same material stacked in an interleaved manner, and achieves DOI discrimination by utilizing a characteristic of light distribution of scintillation light on a surface of a photoelectric component. The U-shape structure and the Prism structure use a bridge structure to achieve scintillation light sharing between adjacent crystals and, DOI discrimination is achieved by calibrating differences in light sharing at different depths. The Phosphor-coated structure achieves DOI discrimination by spraying a wavelength-shifting fluorescent material on a crystal surface and utilizing light emission characteristics at different depths. The differentiated built-in light-splitting structure utilizes light-splitting materials with different characteristics to perform depth encoding at different depths of the crystal array, changing propagation paths of scintillation light at different depths. DOI discrimination is achieved by calibrating a relationship between depth and light output distribution characteristics. The Side-readout structure changes light output of a crystal from an end surface readout to a side surface readout, increasing a granularity of photoelectric readout. DOI discrimination is achieved by utilizing weight characteristics of light distribution at different positions. The Monolithic structure and the Semi-Monolithic structure achieve DOI discrimination through differences in spots of scintillation light on a surface of a photoelectric array at different positions and depths of the crystal.

However, structures such as the Phoswich structure, the Stacked Matrices structure, the Phosphor-coated structure, and the differentiated built-in light-splitting structure require stacking a plurality of material layers. Furthermore, DOI capability is positively correlated with the count of stacked layers. Under requirements for high DOI response capability, such as in animal systems, the Phoswich structure, the Stacked Matrices structure, the Phosphor-coated structure, and the differentiated built-in light-splitting structure are relatively complex, with high cost and high implementation difficulty, and consistency is difficult to ensure. The U-shape structure and the Prism structure use a bridged Bridge structure, where a plurality of discrete crystals are lapped to each other to a obtain light distribution capability between crystal units. This requires high precision for array assembly. Furthermore, due to an existence of a bridge air interface, scintillation light may undergo total reflection, refraction, and other interface reactions at this location, reducing consistency of light sharing. Simultaneously, the structure of a U-shaped crystal may cause depth positioning errors to be biased toward a bridge when Compton scattering of a ray occurs between two crystals, reducing an accuracy of DOI discrimination. The count of photoelectric components required for the Side-readout structure and the multi-end readout structure will be several times that of conventional readout. Pressures of the Side-readout structure and the multi-end readout structure on readout electronics channels and cost pressure will be a major challenge. The Monolithic structure and the Semi-Monolithic structure have high requirements for a count of independent channels for photoelectric readout. The calibration process for position and depth information in the Monolithic structure and the Semi-Monolithic structure is complex, and significant response dead zones exist at edges of the structure, which is not conducive to large-area tiling. Therefore the Monolithic structure and the Semi-Monolithic structure have not yet been widely adopted.

Therefore, the dual-end structure is still a more commonly used detector structure currently.

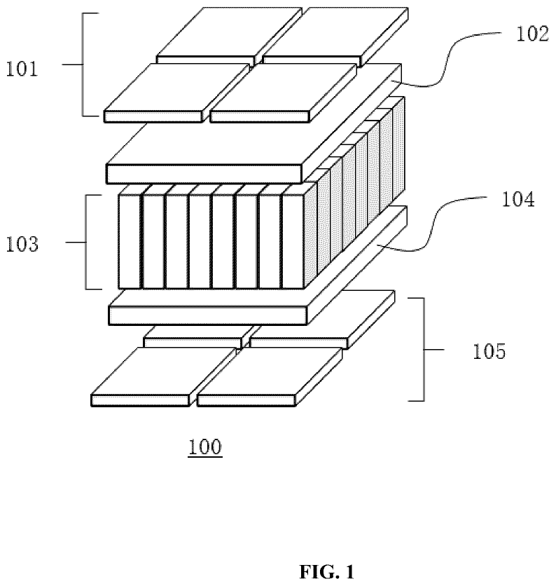

FIG. 1 is a schematic diagram illustrating a structure of an exemplary PET detector in the related art. As shown in FIG. 1, the dual-end structure may include a photoelectric component 101, a light guide layer 102, a crystal array 103, a light guide layer 104, and a photoelectric component 105. It may be seen that the dual-end structure is provided with a pair of photoelectric components of equal scale at both ends of the crystal array. It should be noted that FIG. 1 shows an example with 2×2 photoelectric components at both ends. The photoelectric components at both ends may also be of other scales. Equal scale refers to arrays of the photoelectric components at both ends being consistent in both a count of the rows and a count of the columns, and a physical size of a single photoelectric component is also the same. For example, a first processing unit includes 4 photoelectric components arranged in 2 rows and 2 columns, a second processing unit also includes 4 photoelectric components arranged in 2 rows and 2 columns, and a physical size of a single photoelectric component is also the same.

Since FIG. 1 adopts a crystal array design with equal-length and fully inserted films, to achieve effective position resolution of an edge crystal array, it is necessary to fill the light guide layer 102 and the light guide layer 104 of a certain thickness between the crystal array and the photoelectric components to create a differentiated light-splitting effect at edges. However, an existence of the light guide layers not only increases a complexity of the detector but also affects transmittance of crystal scintillation light and a collection effect of the photoelectric components for the scintillation light due to an increased count of light transmission interfaces. Furthermore, when forming a detection ring by splicing modules, the simultaneous existence of dual-end photoelectric components of equal scale and the light guide layers, a splicing dead zone is further increased, which reduces a detection efficiency. In addition, to reduce the pressure on readout electronics channels, related technologies often use resistor networks to lead out signals from both ends. However, a signal quality is inversely proportional to a network scale, and a hardware cost is also high.

It is evident that although the dual-end structure can intrinsically obtain better scintillation light transmission characteristics compared to a single-end structure, its widespread application has been limited by factors such as the cost of twice a count of the photoelectric components, an implementation difficulty, a light loss at a plurality of transmission interfaces, and a loss of detection efficiency due to splicing.

Therefore, it is necessary to provide a positron emission tomography detector (also referred to as PET detector in the present disclosure) for a medical scanning device in view of the above technical problems. The detector for the medical scanning device will be introduced below.

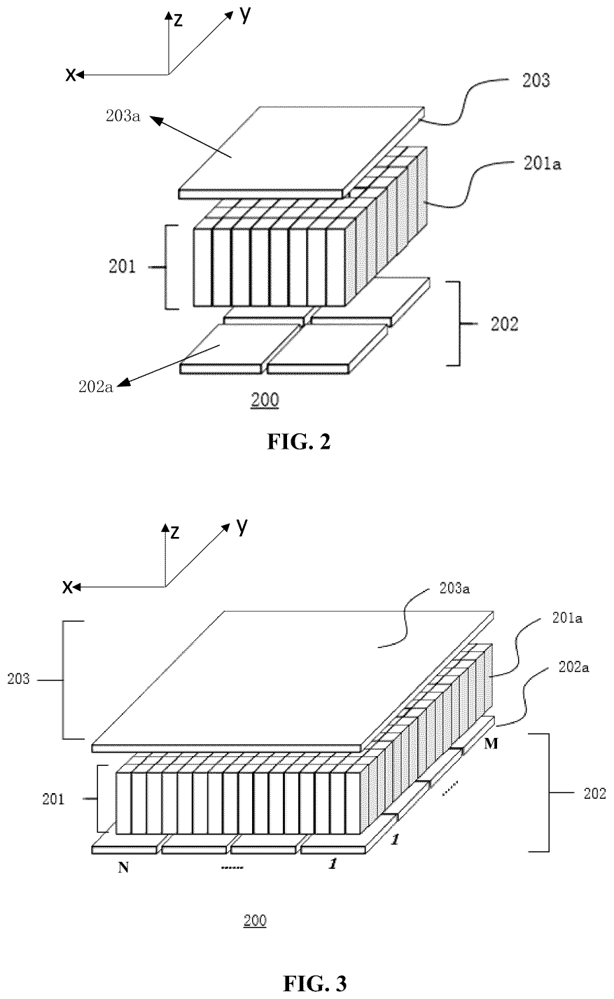

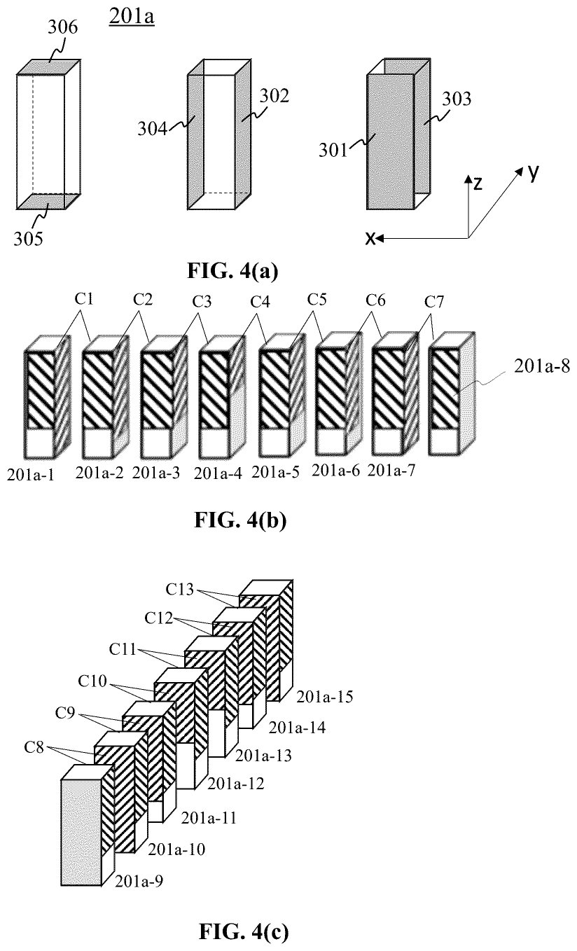

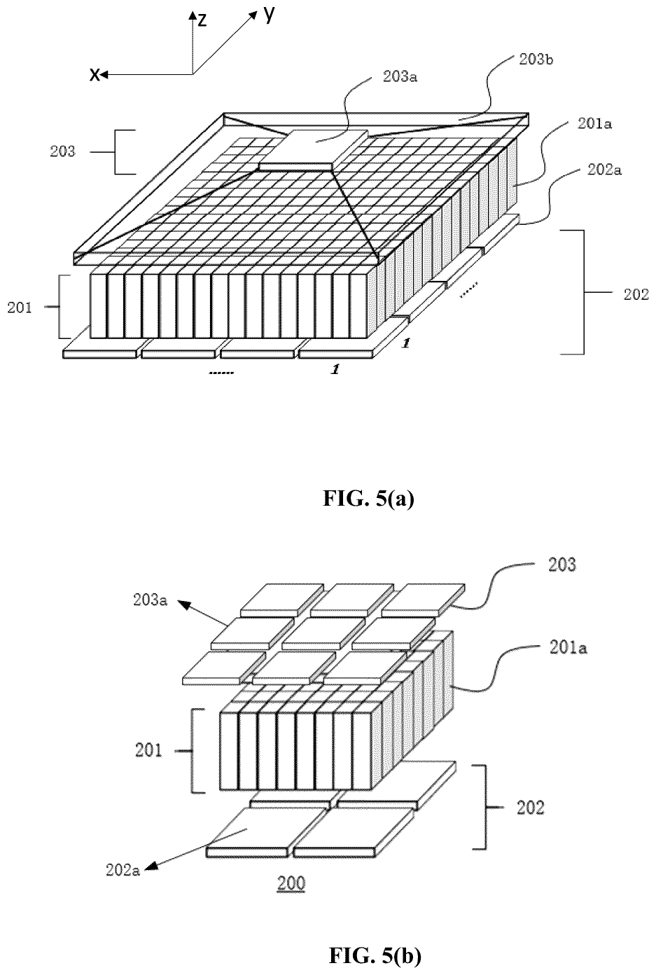

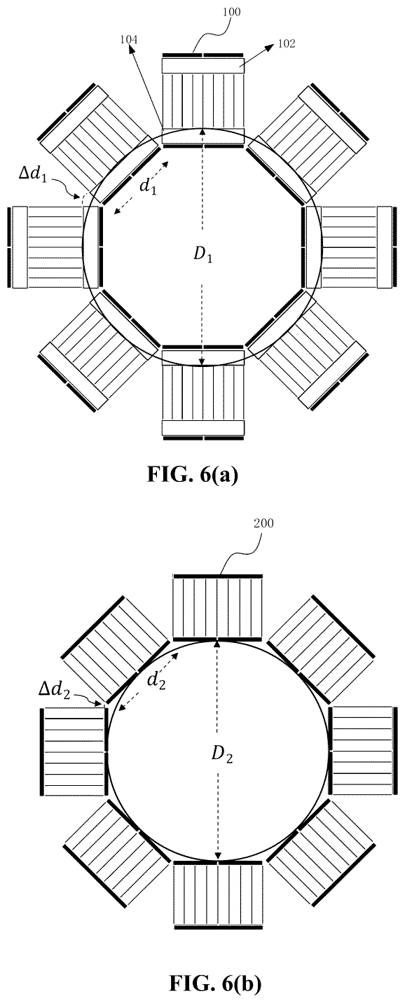

FIG. 2 is a first schematic diagram illustrating a structure of an exemplary dual-ended readout PET detector of a medical scanning device according to some embodiments of the present disclosure. FIG. 3 is a second schematic diagram illustrating a structure of an exemplary dual-ended readout PET detector of a medical scanning device according to some embodiments of the present disclosure. FIG. 4(a)-4(c) are schematic diagrams illustrating an attachment of an exemplary light-splitting structure according to some embodiments of the present disclosure. FIG. 5(a) is a third schematic diagram illustrating a structure of an exemplary dual-ended readout PET detector of a medical scanning device according to some embodiments of the present disclosure. FIG. 5(b) is a fourth schematic diagram illustrating a structure of an exemplary dual-ended readout PET detector of a medical scanning device according to some embodiments of the present disclosure.

In some embodiments, as shown in FIG. 2 and FIG. 3, a detector (dual-ended readout PET detector) 200 of a medical scanning device may include a crystal array 201, a first processing unit 202, and a second processing unit 203. The crystal array 201 may include a plurality of crystal units 201a. The first processing unit 202 is disposed at a first end of the crystal array 201. The second processing unit 203 is disposed at a second end of the crystal array 201, and the first end and the second end are disposed opposite to each other. Each of the plurality of crystal units 201a includes a side surface between the first end and the second end, and the side surfaces of at least two of the plurality of crystal units 201a have different optical conductivities.

The crystal array 201 is a core component of the detector 200, and is configured to detect gamma photons and generate scintillation photons.

In PET imaging, a radioactive tracer (e.g., ¹⁸F-FDG) releases positrons (B) within an imaging object. The positrons annihilate with surrounding electrons, producing a pair of gamma photons with an energy of 511 keV, which shoot out in opposite directions. A gamma photon enters the crystal array of the detector and collides with outer electrons of crystal atoms. The gamma photon transfers energy to the outer electrons of the crystal atoms, exciting the outer electrons to jump to a higher energy level (ionization). Subsequently, when the electrons spontaneously return to the ground state, the electrons release energy. The released energy is emitted in a form of visible or ultraviolet light (the scintillation photons) (e.g., a LYSO crystal emits blue light with a wavelength of 420 nm).

The crystal array 201 may include a plurality of crystal units 201a.

The crystal unit 201a is a basic unit of the crystal array 201. The crystal unit 201a may be a scintillation crystal, for example, a LYSO crystal, a LSO crystal, a BGO crystal, or the like. In some embodiments, each crystal unit 201a has a top surface, a bottom surface, and a side surface. The bottom surface and the top surface are disposed opposite to each other along an axis (an extension direction or an axial direction) of the crystal unit (e.g., a z-direction in FIG. 2). The side surface is located between the top surface and the bottom surface. For example, the top surface and the bottom surface are perpendicular to the axis of the crystal unit 201a, and the side surface is located between the top surface and the bottom surface and parallel to the axis of the crystal unit 201a. For example, the crystal unit may be a cuboid, or other shapes. More details regarding the structure of the crystal unit can be found in descriptions in connection with FIG. 4(a).

The plurality of crystal units 201a are arranged in a manner that their axes (e.g., the extension directions) are parallel to each other, along a row direction (e.g., an x-direction in FIG. 2) and a column direction (e.g., a y-direction in FIG. 2), to form a plurality of crystal unit rows and a plurality of crystal unit columns, thereby forming the crystal array 201 (a pixel array). The row direction, the column direction, and the axial direction of the crystal units are perpendicular to each other. The crystal units in each crystal unit row are arranged along the row direction. The crystal units in each crystal unit column are arranged along the column direction. In the crystal array 201, the bottom surfaces of the plurality of crystal units 201a form a first light emitting surface (the first end) of the crystal array, and the top surfaces of the plurality of crystal units 201a form a second light emitting surface (the second end) of the crystal array.

The first end of the crystal array 201 is the end where the bottom surfaces of the plurality of crystal units 201a are located. The second end of the crystal array 201 is the end where the top surfaces of the plurality of crystal units 201a are located. The first end and the second end of the crystal array 201 are disposed at opposite ends of the crystal units 201a along the axial direction.

Referring to FIG. 2, since scintillation photon transmission is isotropic, photons of the scintillation light generated by the crystal array 201 may travel along the axial direction of the crystal units 201a, i.e., transmit between the first end and the second end of the crystal array 201. On one hand, a portion of the scintillation photons generated by the crystal array 201 emits from the first light emitting surface at the first end of the crystal array 201 and reaches the first processing unit 202 through the first light emitting surface. On the other hand, another portion of the scintillation photons generated by the crystal array 201 emits from a second light emitting surface at the second end of the crystal array 201 and reaches the second processing unit 203 through the second light emitting surface. Merely by way of example, the first processing unit 202 may be attached to the first light emitting surface, and/or the second processing unit 203 may be attached to the second light emitting surface.

A single crystal unit 201a is fully transparent. That is, each crystal unit 201a in the crystal array 201 does not inherently possess light-splitting differential characteristics. Therefore, to enable the crystal unit 201a to have differentiated light-splitting characteristics for encoding a light path, a light-splitting structure is disposed on a side surface of the crystal unit 201a in this embodiment.

The light-splitting structure refers to a structure or component capable of guiding and controlling a propagation path of scintillation photons. The light-splitting structure can be integrated on the side surface of the crystal unit 201a. For example, the light-splitting structure may be an optical film (e.g., a reflective film, an anti-reflective film) coated on the side surface of the crystal unit 201a, a reflective material (e.g., a high-efficiency reflective sheet) attached on the side surface of the crystal unit 201a, or an etched microstructure (e.g., a micro-prism).

This embodiment utilizes the light-splitting structure to perform position encoding on a transmission path of scintillation light generated by each crystal unit 201a in the crystal array 201, thereby serving to build a light-splitting structure within the crystal array 201.

The light-splitting structure includes various optically transparent materials, such as glass, plastic, or an adhesive with a variable thickness (e.g., ranging from μm to mm). The light-splitting structure may be applied to the side surface of the crystal unit 201a. The light-splitting structure may be made into a film and attached to the side surface of the crystal unit 201a. Other processes may be used to dispose the light-splitting structure on the side surface of the crystal unit 201a. Alternatively, a groove or a slit may be formed on the side surface of the crystal unit 201a to form the light-splitting structure. This embodiment is not limited thereto.

Further optionally, the light-splitting structure may be a reflective material. A reflective material refers to a material with light-blocking characteristics capable of preventing photons from passing through. The reflective material may include, but is not limited to, barium sulfate, a high-reflection coating, or a high-efficiency reflective sheet (Enhanced Specular Reflector, ESR).

It should be noted that the light-splitting structure may be disposed on one side surface of the crystal unit 201a, on a plurality of side surfaces of the crystal unit 201a, or on all side surfaces of the crystal unit 201a.

In one embodiment, side surfaces of at least two crystal units 201a among the plurality of crystal units 201a have different optical conductivities. That is, the light-splitting structures with different characteristics may be disposed on side surfaces of different crystal units 201a, so that the side surfaces of the different crystal units 201a have different optical conductivities.

In some embodiments, characteristics of the light-splitting structure may include an attachment area, a material, an attachment shape, etc. This embodiment is not limited thereto, as long as the crystal unit 201a is enabled to possess differentiated light-splitting characteristics. Merely by way of example, the side surface of the crystal unit 201a may be covered with reflective materials of different lengths. A purpose of the reflective material is to block light and reflect light. A portion of the side surface that is not covered by the reflective material allows light transmission, thereby controlling scintillation photons to be transmitted according to a certain encoding rule.

In related art, a dual-end structure typically has difficulty in directly resolving an effective interaction position of a ray on outermost and sub-outermost rings of a crystal array. Therefore, a light guide layer needs to be added between a processing unit and the crystal array (along the axial direction of the crystal unit) to enhance an edge light-splitting effect. In this embodiment, the light-splitting structures on the side surfaces of the crystal units enables building a differentiated light-splitting structure within the crystal array, so that the periphery and the inner layer of the crystal array possess differentiated light-splitting effects. Therefore, the first processing unit and/or the second processing unit can be directly coupled to the crystal array without light guide disposed between the processing unit and the crystal array (along the axial direction of the crystal unit).

The first processing unit 202 is disposed at the first end of the crystal array 201 and is configured to acquire photon information of scintillation photons emitted from the first light emitting surface. The second processing unit 203 is disposed at the second end of the crystal array 201 and is configured to acquire photon information of scintillation photons emitted from the second light emitting surface.

In some embodiments, the first processing unit 202 and the second processing unit 203 each include at least one photoelectric component. The photoelectric component refers to a semiconductor device capable of converting an optical signal into an electrical signal. As an example, the photoelectric component may include a Silicon Photomultiplier (SiPM), a PhotoMultiplier Tube (PMT), an Avalanche PhotoDiode (APD), a digital Silicon PhotoMultiplier (dSiPM), etc.

The photon information includes a count of scintillation photons detected by the photoelectric component, an energy of the scintillation photons detected by the photoelectric component, etc. The count of scintillation photons is proportional to the energy of the scintillation photons. The energy of the scintillation photons is used to locate response distribution information of a gamma photon. In other words, the photon information acquired by the first processing unit 202 characterizes an energy of scintillation photons detected by the first processing unit 202. The photon information acquired by the second processing unit 203 characterizes an energy of scintillation photons detected by the second processing unit 203.

In the above embodiment, a detector of a medical scanning device includes a crystal array, a first processing unit, and a second processing unit. The crystal array includes a plurality of crystal units. The first processing unit is disposed at a first end of the crystal array. The second processing unit is disposed at a second end of the crystal array. The first processing unit includes a plurality of first photoelectric components. The second processing unit includes at least one second photoelectric component. By disposing the light-splitting structures on the side surfaces of the crystal units and making optical conductivities of side surfaces of at least two crystal units different, reflection of scintillation photons to the first processing unit and the second processing unit by the light-splitting structure inside the crystal array is achieved. Therefore, the photon information may be directly acquired at the first processing unit and the second processing unit without disposing a light guide layer between the crystal array and the first processing unit and/or between the crystal array and the second processing unit. Furthermore, 2D position information may be determined based on the photon information acquired by the first processing unit. Response depth information may be determined based on the photon information acquired by the first processing unit and the photon information acquired by the second processing unit.

In some embodiments, the first processing unit 202 is configured to collect scintillation photons emitted from the first end, and determine 2D position information and first energy information of the scintillation photons emitted from the first end. The second processing unit 203 is configured to collect scintillation photons emitted from the second end and determine second energy information of the scintillation photons emitted from the second end. Response depth information may be determined based on the first energy information and the second energy information.

The first energy information refers to an energy of scintillation photons acquired by the first processing unit 202. The second energy information refers to an energy of scintillation photons acquired by the second processing unit 203.

The 2D position information refers to information used to locate a response position of a gamma photon. The 2D position information refers to two-dimensional (2D) position coordinates, on a two-dimensional plane (e.g., the x-y plane shown in FIG. 2), of a position where a gamma photon interacts with the crystal array to generate scintillation light (scintillation photons) within the crystal array. The response depth information refers to a coordinate, along a depth direction of the crystal array (e.g., the extending direction of the crystal units and the z direction in FIG. 2), of a position where a gamma photon interacts with the crystal array to generate scintillation light (scintillation photons) within the crystal array.

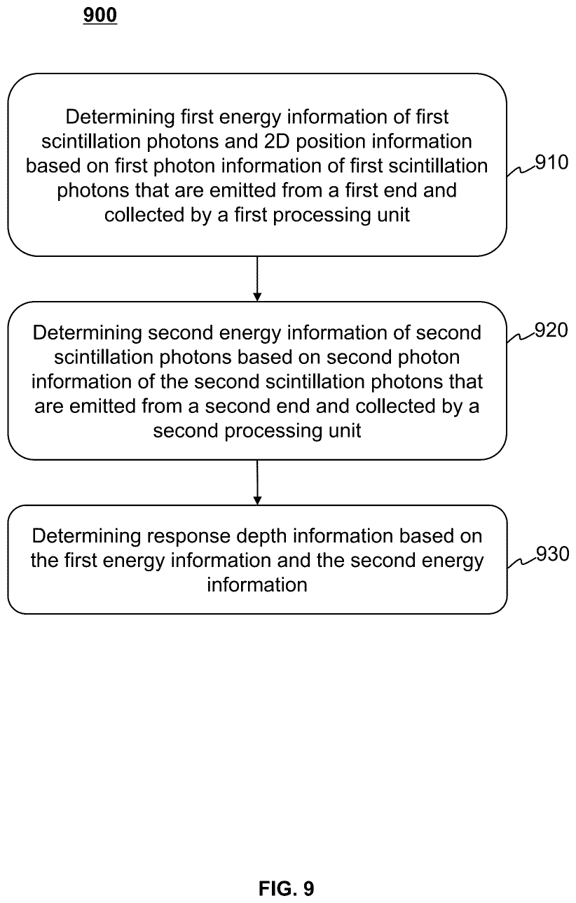

For more description regarding determining the 2D position information, the first energy information, and the second energy information, refer to FIG. 9 and its related description.

In some embodiments of the present disclosure, by configuring the first processing unit to acquire scintillation photons emitted from the first end, and determine 2D position information and first energy information of the scintillation photons emitted from the first end, and configuring the second processing unit to acquire scintillation photons emitted from the second end and determine second energy information of the scintillation photons emitted from the second end, the second processing unit does not need to determine the 2D position information. This reduces the requirement of the configuration of the second processing unit and reduces cost.

In some embodiments, a configuration of the first processing unit 202 is different from a configuration of the second processing unit 203.

In some embodiments, the configuration of a processing unit includes at least one of a hardware configuration (e.g., a size (e.g., a coverage area), and/or a count of the photoelectric components, etc.), a function (e.g., tasks and responsibilities undertaken by the processing unit), or a performance characteristic (e.g., a detection range, a complexity of a readout circuit, etc.). Correspondingly, the configuration of the first processing unit 202 and the configuration of the second processing unit 203 being different may include at least one of the following: a count of the photoelectric components of the first processing unit 202 and a count of the photoelectric components of the second processing unit 203 being different; a size of a single photoelectric component of the first processing unit 202 and a size of a single photoelectric component of the second processing unit 203 being different; a function of the first processing unit 202 and a function of the second processing unit 203 being different (e.g., the first processing unit 202 is used to determine the 2D position information and the first energy information, and the second processing unit 203 is used to determine the second energy information without determining the 2D position information); a detection range of the first processing unit 202 and a detection range of the second processing unit 203 being different (i.e., asymmetric); or a complexity of a readout circuit of the first processing unit 202 and a complexity of a readout circuit of the second processing unit 203 being different.

In some embodiments, a count of the photoelectric components of the first processing unit 202 is greater than a count of the photoelectric components of the second processing unit 203.

The detection range refers to a spatial region in which a processing unit (e.g., the photoelectric components) is capable of effectively collecting scintillation photons and generate an electrical signal. In some embodiments, because the generated scintillation photons need to be reflected to the first processing unit 202 and the second processing unit 203, a difference between an area of the detection range of the first processing unit 202 and a coverage area of the first end needs to be smaller than a first preset difference. A difference between an area of the detection range of the second processing unit 203 and a coverage area of the second end needs to be smaller than a second preset difference. The first preset difference and the second preset difference can be set according to requirements.

Merely by way of example, the area of the detection range of the first processing unit 202 can be the same as the coverage area of the first end. The area of the detection range of the first processing unit 202 can also be greater than or slightly smaller than the coverage area of the first end. Similarly, the area of the detection range of the second processing unit 203 can be the same as the coverage area of the second end. The area of the detection range of the second processing unit 203 can also be greater than or slightly smaller than the coverage area of the second end.

Readout circuit complexity refers to a complexity level of an electronic readout circuit required to process signals from a processing unit. The first processing unit 202 is connected to a large count of photoelectric components. A multi-channel application-specific integrated circuit (ASIC) is required to process signals from each photoelectric component in parallel to determine 2D position information, resulting in high circuit complexity. The second processing unit only needs to process signals from one or a few channels. Its readout circuit is very simple and has low complexity.

In some embodiments of the present disclosure, setting the functions of the first processing unit and the second processing unit to be different enables functional specialization. The first processing unit focuses on spatial resolution. The second processing unit focuses on providing key parameters for calculating response depth information. The division of labor of the first processing unit and the second processing unit is clear, and the efficiency of the first processing unit and the second processing unit is higher. This avoids configuring a complex and expensive multi-channel readout circuit for the second processing unit, further optimizing cost. Accordingly, the detection range of the second processing unit does not need to be the same as the detection range of the first processing unit, reducing manufacturing and assembly precision requirements for the second processing unit, thereby saving costs. The count of the photoelectric components in the second processing unit may be less than the count of photoelectric components in the first processing unit, thereby greatly reducing the total count of the photoelectric components and the count of subsequent electronic readout channels, which is the most critical factor in reducing system cost and complexity.

In some embodiments, the detection range of the first processing unit 202 completely covers the first end. The detection range of the second processing unit 203 at least partially covers the second end.

In some embodiments, the detection range of the first processing unit 202 completely covering the first end refers to that a combined detection range of all photoelectric components of the first processing unit 202 completely covers an entire light emitting surface of the first end of the crystal array 201. For example, a projection of a combined detection range of all photoelectric components of the first processing unit 202 on the light emitting surface of the first end along the axial direction of the crystal units completely covers or overlaps the entire light emitting surface of the first end of the crystal array 201. The detection range of the second processing unit 203 at least partially covering the second end refers that a combined detection range of all photoelectric components of the second processing unit 203 partially or completely covers an entire light emitting surface of the second end of the crystal array 201. As an example, the combined detection range of all photoelectric components of the second processing unit 203 can cover an entire area of the second end, cover a local area of the second end, indirectly cover a partial area of the second end via a light guide component, or cover the second end via sparse sampling, etc. Merely by way of example, a projection of a combined detection range of all photoelectric components of the second processing unit 203 on the light emitting surface of the second end along the axial direction of the crystal unit covers or overlaps the entire light emitting surface or a portion of the entire light emitting surface of the second end of the crystal array 201.

In some embodiments, the first processing unit includes a plurality of first photoelectric components, and the second processing unit includes one or more second photoelectric components. The plurality of first photoelectric components completely cover the first end of the crystal array, meaning that a projection of the plurality of first photoelectric components on the first end along the axial direction (e.g., the z-direction) of the crystal array completely covers the first end. The one or more second photoelectric components at least partially cover the second end of the crystal array, meaning that a projection of the one or more second photoelectric components on the second end along the axial direction (e.g., the z-direction) of the crystal array at least partially covers the second end, e.g., the projection of the one or more second photoelectric components on the second end along the axial direction (e.g., the z-direction) of the crystal array completely or partially covers the second end.

In some embodiments of the present disclosure, by setting the detection range of the first processing unit to completely cover the first end, the 2D position information can be accurately determined under the combined effect of different optical conductivities on internal side surfaces of the crystal array. By setting the detection range of the second processing unit to at least partially cover the second end, installation precision requirements for the second processing unit can be reduced, assembly difficulty can be lowered, and production yield and efficiency can be improved. The “asymmetry of detection ranges” of the first processing unit and the second processing unit is an astute engineering design concept. It adopts differentiated precision investment in links with different functions, concentrating limited resources and costs on the first processing unit which most affects core performance (spatial positioning), while appropriately simplifying secondary links (energy collection end). This ultimately achieves an optimal balance between overall system performance and manufacturing cost.

In the above embodiments, because the difference between the area of the detection range of the first processing unit and the coverage area of the first end is smaller than the first preset difference, and the difference between the area of the detection range of the second processing unit and the coverage area of the second end is smaller than the second preset difference, the 2D position information of photons can be accurately determined via the first processing unit. Furthermore, response depth information, energy, or time of the scintillation photons can be accurately determined in combination with the second processing unit.

In some embodiments, as shown in FIG. 2 and FIG. 3, the first processing unit 202 includes a plurality of first photoelectric components 202a. The second processing unit 203 includes at least one second photoelectric component 203a.

The first photoelectric component 202a refers to a photoelectric component disposed in the first processing unit 202. The second photoelectric component 203a refers to a photoelectric component disposed in the second processing unit 203.

In some embodiments, the first photoelectric components 202a may be coupled to the first light emitting surface. The second photoelectric component 203a may be coupled to the second light emitting surface.

In some embodiments, the plurality of first photoelectric components are distributed in a 2D pattern.

In some embodiments, the plurality of first photoelectric components 202a may be arranged in an array in the first processing unit 202, and at least one second photoelectric component 203a may be arranged in an array in the second processing unit 203. For example, as shown in FIG. 2 and FIG. 3, the plurality of first photoelectric components 202a are arranged along a row direction (e.g., the x-direction in FIG. 2) and a column direction (e.g., the y-direction in FIG. 2) to form a plurality of photoelectric component rows and a plurality of photoelectric component columns, forming a photoelectric component array. The first photoelectric components in each photoelectric component row are arranged along the row direction, and the first photoelectric components in each photoelectric component column are arranged along the column direction. For example, as shown in FIG. 3, the plurality of first photoelectric components 202a are arranged along the row direction and the column direction to form M photoelectric component rows and N photoelectric component columns, thereby forming a photoelectric component array. As shown in FIG. 3, the numbers 1-M represent the sequence number of the M photoelectric component rows, and the numbers 1-N represent the sequence number of the N photoelectric component columns.

The principle of the array arrangement of the at least one second photoelectric component 203a may be similar to that of the plurality of first photoelectric components 202a, which is not repeated here.

In some embodiments, a count of the first photoelectric components 202a is different from a count of the second photoelectric components 203a.

In some embodiments, a count of the second photoelectric components 203a is smaller than a count of the first photoelectric components 202a.

In some embodiments, a count of the second photoelectric components 203a is smaller than a count of the first photoelectric components 202a, and a coverage area of a single second photoelectric component 203a is greater than a coverage area of a single first photoelectric component 202a.

Taking FIG. 2 as an example, the first processing unit 202 may include 4 first photoelectric components 202a arranged in 2 rows and 2 columns. The second processing unit 203 may include one second photoelectric component 203a. Taking FIG. 3 as an example, the count of the first photoelectric components 202a may be N×M (M and N are integers greater than or equal to 1). The count of the second photoelectric components 203a may be 1.

As an example, a first photoelectric component can be a 3 mm×3 mm SiPM. A second photoelectric component may be a 6 mm×6 mm SiPM. The first processing unit uses high-density, small-size photoelectric components, which can provide finer spatial sampling (requires determining 2D position information and energy information). The second processing unit uses large-size, low-quantity photoelectric components (requires determining energy information and response depth information), which can reduce costs.

In some embodiments, a count of the first photoelectric components may be equal to a count of the second photoelectric components.

In some embodiments of the present disclosure, by setting the count of second photoelectric components to be smaller than the count of first photoelectric components, hardware cost of the detector can be effectively reduced, implementation difficulty of the detector can be lowered, and optical interface transmission loss and detection efficiency loss caused by introducing a light guide layer can be avoided, thereby improving precision of the detector. Signal collection efficiency is ensured by using large-size second photoelectric component, compensating for the deficiency in quantity.

In some embodiments, as shown in FIG. 5(a), a detection range of at least one second photoelectric component 203a at least partially covers the second end. The detection range of the second processing unit 203 at least partially covering the second end refers that a detection range of a combination of all photoelectric components of the second processing unit 203 covers at least a partial area of a second light emitting surface of the second end of the crystal array 201. For example, the detection range of the combination of all photoelectric components of the second processing unit 203 may cover a local area of the second end, indirectly cover a partial area of the second end via an light-splitting component, or cover the second end via sparse sampling.

In some embodiments, as shown in FIG. 5(a), when the detection range of the at least one second photoelectric component 203a included in the second processing unit 203 partially covers the second end, the second processing unit 203 further includes a light guide 203b. Along the axial direction of the crystal units, the light guide 203b is located between the crystal array 201 and the second processing unit 203. The light guide 203b is configured to converge scintillation photons emitted from the second end to the at least one second photoelectric component 203a. For example, the second processing unit 203 may include one second photoelectric component 203a and a light guide 203b connected to the second photoelectric component 203a.

The light guide 203b refers to an optical element for guiding and converging photons. For example, the light guide 203b may be an optical fiber bundle, a microstructure light guide, or the like.

The light guide 203b is configured to effectively collect scintillation photons emitted from the second light emitting surface of the second end of the crystal array 201 and conduct the photons to the second photoelectric component 203a that at least partially covers the second end.

In some embodiments, an area of a first end surface of the light guide 203b is different from an area of a second end surface of the light guide 203b. The first end surface of the light guide 203b is an end surface facing the second light emitting surface of the crystal array 201. The second end surface of the light guide 203b is an end surface facing away from the second light emitting surface of the crystal array 201. The second end surface of the light guide 203b may face the second photoelectric component.

The light guide 203b may include, but is not limited to, a wedge-shaped light guide. The light guide 203b is connected to the second photoelectric component 203a. The light guide 203b is configured to collect light output from the crystal array 201. The second photoelectric component 203a is configured to receive effective light output collected by the light guide, thereby acquiring effective photon information on the second light emitting surface.

When a total effective photosensitive area of the second photoelectric component 203a is smaller than a total light-emitting area of the second end of the crystal array 201a, photon collection may be indirectly implemented via other optical means, e.g., converging photons to the second photoelectric component 203a via the light guide 203b.

In some embodiments of the present disclosure, because the second processing unit includes a plurality of second photoelectric components, or the second processing unit includes one second photoelectric component and a light guide connected to the second photoelectric component, the second processing unit has high flexibility. In a case where the second processing unit includes one second photoelectric component and a light guide connected to the second photoelectric component, the light guide and the second processing unit are located on the same side of the crystal array. Therefore, when a plurality of detectors are spliced into a detection ring, the light guide is located on the outer side of the detection ring, which does not increase a splicing dead zone.

In some embodiments, as shown in FIG. 5(b), the at least one second photoelectric component 203a of the second processing unit 203 completely covers the second end, and the count of the second photoelectric components 203a is greater than the count of the first photoelectric components 202a. In some embodiments, the at least one second photoelectric component 203a completely covering the second end means that a detection range of a combination of the at least one second photoelectric component 203a completely covers an entire light emitting surface of the second end of the crystal array 201. For example, as shown in FIG. 5(b), the first processing unit 202 includes 2×2 first photoelectric components 202a of which the detection ranges completely covers the entire light emitting surface of the first end, and the second processing unit 203 includes 3×3 second photoelectric components 203a of which the detection ranges completely covers the entire light emitting surface of the second end.

In some embodiments of the present disclosure, by arranging the at least one second photoelectric component to completely cover the second end and making the count of the second photoelectric components greater than the count of the first photoelectric components, the response depth information of photons can be determined more accurately.

In summary, the first processing unit is configured to determine the 2D position information, while the second processing unit is configured to determine the response depth information without needing to determine the 2D position information. To determine the 2D position information, the first processing unit requires higher specifications, whereas the second processing unit does not require such capabilities. Therefore, the second processing unit docs not need specifications as high as the first processing unit, meaning its configuration can be lower than that of the first processing unit. For example, the count of the photoelectric components in the first processing unit is greater than that in the second processing unit; and/or, the size of each photoelectric component in the first processing unit is smaller than that in the second processing unit; and/or, the detection range of the first processing unit fully covers the first end, while the detection range of the second processing unit only partially covers the second end; and/or, the readout circuit complexity of the first processing unit is higher than that of the second processing unit. By reducing the specifications or configuration of the second processing unit, the manufacturing and assembly precision requirements for the second processing unit are lowered, thereby reducing costs.

In some embodiments, as shown in FIGS. 2 and 3, the plurality of crystal units are arranged into multiple rows and multiple columns along a first direction x (the row direction) and a second direction y (the column direction). In each row, the crystal units 201a are arranged along the first direction x. In each column, the crystal units 201a are arranged along the second direction y. A side surface of each crystal unit 201a includes a row side surface parallel to the first direction x and a column side surface parallel to the second direction y. For at least one row of crystal units 201a, optical conductivities of at least two column side surfaces of the crystal units 201a in the same row are different. For at least one column of crystal units 201a, optical conductivities of at least two row side surfaces of the crystal units 201a in the same column are different.

Continuing to refer to FIG. 2 or FIG. 3, because light-splitting structures with different characteristics are provided on the side surfaces of the crystal unit 201a, the crystal unit 201a has differentiated light-splitting characteristics. Thus, the light-splitting structures of the crystal units 201a can reflect the generated scintillation photons to the first processing unit 202 and the second processing unit 203 in a specific encoded form.

The first direction and the second direction are not limited, as long as they are perpendicular to each other.

In some embodiments, a count of the rows and a count of the columns of the array formed by the plurality of crystal units 201a may be the same or different. For example, the count of the rows and the count of the columns of the array formed by the plurality of crystal units 201a may be set according to actual needs, which is not limited in this embodiment.

In some embodiments, a side surface of each crystal unit includes a row side surface and a column side surface. As shown in FIG. 4(a), taking a crystal unit 201a being a cuboid as an example, the crystal unit 201a includes an upper surface (top surface) 306, a lower surface (bottom surface) 305, and four side surfaces 301-304. The top surface 306 and the bottom surface 305 are oppositely disposed along an axis (extension direction z) of the crystal unit and are perpendicular to the axis. The side surfaces 301-304 are located between the top surface 306 and the bottom surface 305 (along the z direction). The side surface of the crystal unit 201 includes two row side surfaces and two column side surfaces. The row side surface refers to a side surface of the crystal unit parallel to the row direction, e.g., row side surface 301 and row side surface 303. The column side surface refers to a side surface of the crystal unit parallel to the column direction, e.g., column side surface 302 and column side surface 304.

The optical conductivity refers to a quantitative characterization of photon guiding efficiency of a side surface (the row side surface or the column side surface) of a crystal unit. The optical conductivity reflects a comprehensive control capability of the side surface for reflection, transmission, or absorption of photons.

In some embodiments, optical conductivities of the at least two column side surfaces of the crystal units 201a in the same row change in the first direction. For example, in the same row, along a positive direction or a negative direction of the row direction, optical conductivities of the at least two column side surfaces of the crystal units 201a gradually increase or decrease. Merely by way of example, as shown in FIG. 2 or FIG. 3, the positive direction of the row direction (x direction) is from right to left. For crystal units in the same row, the column side surface of the leftmost crystal unit 201a has the highest optical conductivity. Along the negative direction of the row direction, optical conductivities of at least two column side surfaces of the crystal units gradually decrease. The column side surface of the rightmost crystal unit 201a has the lowest optical conductivity.

In some embodiments, optical conductivities of at least two row side surfaces of the crystal units 201a in the same column change in the second direction. For example, in the same column, along a positive direction or a negative direction of the column direction, optical conductivities of the at least two row side surfaces of the crystal units 201a gradually increase or decrease. Merely by way of example, as shown in FIG. 2 or FIG. 3, the positive direction of the column direction (y direction) is from front to back. For crystal units in the same column, the row side surface of the foremost crystal unit 201a has the highest optical conductivity. Along the positive direction of the column direction, optical conductivities of the at least two row side surfaces of the crystal units gradually decrease. The column side surface of the rearmost crystal unit 201a has the lowest optical conductivity.

In some embodiments, features (e.g., at least one of an attachment area, a material, or an attachment shape) of light-splitting structures on column side surfaces of a plurality of crystal units 201a in a same row are different. This causes optical conductivities of the at least two column side surfaces of the plurality of crystal units 201a in the same row to be different.

In some embodiments, features (e.g., at least one of an attachment area, a material, or an attachment shape) of light-splitting structures on row side surfaces of a plurality of crystal units 201a in a same column are different. This causes optical conductivities of the at least two row side surfaces of the plurality of crystal units 201a in the same column to be different.

By way of example, taking a light-splitting structure including a reflective material as an example, for crystal unit A1 and crystal unit B1 in the same column, crystal unit A1 is located in the second row of crystal array 201, and crystal unit B1 is located in the third row of crystal array 201. An attachment area of the reflective material in side surface 301 of crystal unit A1 may be 90%. An attachment area of the reflective material in side surface 303 of crystal unit A1 may be 80%. An attachment area of the reflective material in side surface 301 of crystal unit B1 may be 80% (shared with side surface 303 of crystal unit A1). An attachment area of the reflective material in side surface 303 of crystal unit B1 may be 60%, and so on. It should be noted that an attachment area of 90% means that an attachment area of the reflective material accounts for 90% of the row side surface or the column side surface. Others are similar.

As another example, for crystal unit A2 and crystal unit B2 in the same row, crystal unit A2 is located in the third column of crystal array 201, and crystal unit B2 is located in the fourth column of crystal array 201. An attachment area of the reflective material in side surface 302 of crystal unit A2 may be 60%. An attachment area of the reflective material in side surface 304 of crystal unit A2 may be 80%. An attachment area of the reflective material in side surface 302 of crystal unit B2 may be 40%. An attachment area of the reflective material in side surface 304 of crystal unit B2 may be 60% (shared with side surface 302 of crystal unit A2), and so on.

In some embodiments of the present disclosure, by changing lateral optical conductivity of crystals in two dimensions, two-dimensional encoding of photon propagation paths is achieved. This enables differentiated control of optical conductivity of side surfaces of crystal units, thereby providing unique and distinguishable signal features for calculating a two-dimensional plane position of photons.

In some embodiments, for at least one row of crystal units 201a, optical conductivities of the at least two column side surfaces of crystal units 201a in the same row increase from both ends toward the center of the crystal unit row. For example, in the same row of crystal units, column side surfaces of crystal units located at both ends (e.g., the leftmost crystal unit and the rightmost crystal unit in the same row of crystal units in FIG. 4(b)) are set to a low optical conductivity. Column side surfaces of middle crystal units are set to a high optical conductivity. The optical conductivity of the column side surfaces gradually increases from both ends toward the center of the crystal unit row.

In some embodiments, for at least one row of crystal units 201a, optical conductivities of the at least two column side surfaces of crystal units 201a in the same row increase symmetrically from both ends toward the center of the crystal unit row.

In some embodiments, for at least one column of crystal units 201a, optical conductivities of the at least two row side surfaces of crystal units 201a in the same column increase from both ends toward the center of the crystal unit column. For example, in the same column of crystal units, row side surfaces of crystal units located at both ends (e.g., the foremost crystal unit and the rearmost crystal unit in the same row of crystal units in FIG. 2 or FIG. 3) are set to a low optical conductivity. Row side surfaces of middle crystal units are set to a high optical conductivity. The optical conductivity of the row side surfaces gradually increases from both ends toward the center of the crystal unit column. In some embodiments, for at least one column of crystal units 201a, optical conductivities of the at least two row side surfaces of crystal units 201a in the same column increase symmetrically from both ends toward the center of the crystal unit column.

In some embodiments of the present disclosure, by setting lateral optical conductivity of crystal units in a same row or a same column to increase from both ends toward a middle, photon propagation paths at different positions have different optical guiding characteristics. This enables position encoding of photons. Through a symmetrical and smooth gradient variation, a strong correlation exists between position and light output distribution characteristics. This helps improve uniformity and accuracy of position resolution compared to traditional uniform arrays where edge units have weak and diffuse signals leading to inaccurate positioning. By controlling more reflective material to be set at edges, photons can be more easily guided to a processing unit, thereby improving positioning accuracy and efficiency.

In some embodiments, optical conductivities of the at least two row side surfaces of crystal units 201a in the same row are the same. Optical conductivities of the at least two column side surfaces of crystal units 201a in the same column are the same. For example, in an array arrangement, attachment areas of light-splitting structures on row side surfaces of crystal units 201a located at the same row are the same. In the array arrangement, attachment areas of light-splitting structures on column side surfaces of crystal units 201a located at the same column are the same. This can cause optical conductivities of the at least two row side surfaces of crystal units 201a in the same row to be the same, and optical conductivities of the at least two column side surfaces of crystal units 201a in the same column to be the same.

Continuing to refer to FIG. 4(b) and FIG. 4(c), the shaded portion is an region where the light-splitting structure is located. FIG. 4(b) shows eight crystal units 201a located in a same row in the crystal array 201. Since the crystal units 201a in FIG. 4(b) are located at different columns in the crystal array 201, attachment areas of the light-splitting structures on column side surfaces 302 of the crystal units 201a in the same row may be different. Similarly, FIG. 4(c) shows eight crystal units 201a located in a same column in the crystal array 201. Since the crystal units 201a in FIG. 4(c) are located at different rows in the crystal array 201, attachment areas of the light-splitting structures on row side surfaces 301 of the crystal units 201a in the same column may be different.

It can be seen that since the crystal units 201a in FIG. 4(b) are located at the same row in the array arrangement, the attachment areas of the light-splitting structures on the row side surfaces 301 of all the crystal units 201a in the same row may be identical. Similarly, since the crystal units 201a in FIG. 4(c) are located at the same column in the array arrangement, the attachment areas of the light-splitting structures on the column side surfaces 302 of all the crystal units 201a in the same column may be identical.

In the above embodiments, since the attachment areas of the light-splitting structures on the row side surfaces of the crystal units located at the same row in the array arrangement may be identical, and the attachment areas of the light-splitting structures on the column side surfaces of the crystal units located at the same column in the array arrangement may be identical, it is further possible to perform position encoding on the crystal array by utilizing the light-splitting structures to form built-in light-splitting structures within the crystal array, enabling the crystal units to possess differentiated light splitting capabilities, thereby allowing the light-splitting structures to reflect scintillation photons generated in response to gamma rays to the first processing unit and the second processing unit according to a certain encoding rule, so as to determine the 2D position information based on the photon information collected by the first processing unit, and determine the response depth information based on the photon information collected by the first processing unit and the photon information collected by the second processing unit.

In some embodiments, for the crystal units in the same row, the two opposite column side surfaces of two adjacent crystal units can be regarded as the same column side surface (also referred to as a common column side surface). For the crystal units in the same column, the two opposite row side surfaces of two adjacent crystal units can be regarded as the same row side surface (also referred to as a common row side surface). The edge side surface of the crystal units in the crystal array has an optical conductivity of 0, meaning that photons will not pass through these edge side surface. The edge side surface refers to a side surface of the outermost crystal units in the crystal array that does not face any side surface of the crystal units in the crystal array. The variation in the optical conductivities of the at least two column side surfaces of the crystal units in the same row refers to the change in the optical conductivities of the at least two common column side surfaces (excluding the edge side surface) of the crystal units in the same row. The variation in the optical conductivities of the at least two row side surfaces of the crystal units in the same column refers to the change in the optical conductivities of the at least two common row side surfaces (excluding the edge side surface) of the crystal units in the same column.

For example, as shown in FIG. 4(b), crystal units 201a-1 to 201a-8 are in the second row of a 7×8 (7 rows and 8 columns) crystal array. For each crystal unit of the crystal units 201a-1 to 201a-8, the column side surface located on the right side of the crystal unit is called a first column side surface, and the column side surface located on the left side of the crystal unit is called the second column side surface. The second column side surface of crystal unit 201a-1 and the first column side surface of crystal unit 201a-8 are the edge column side surfaces. The first column side surface of crystal unit 201a-1 and the second column side surface of crystal unit 201a-2 are regarded as the same column side surface, and are referred to as common column side surface C1; the second column side surface of crystal unit 201a-2 and the first column side surface of crystal unit 201a-3 are regarded as the same column side, and are referred to as common column side surface C2, and so on. The change in the optical conductivities of the at least two column side surfaces of the crystal units in the same row refers to the change in the optical conductivities of at least two common column side surfaces (e.g., C1-C7, excluding the edge column sides) of the crystal units in the same row. For example, as shown in FIG. 4(b), along the row direction, the attached areas of the light guides on the common column side surfaces C1-C7 gradually decrease from both ends to the center, that is, the optical conductivities of the at least two common column side surfaces C1-C7 gradually increase from both ends to the center. Further, the attached areas of the light guides on the common column side surfaces C1-C7 are symmetrically distributed with respect to the common column side surface C4, leading to the optical conductivities of the at least two common column side surfaces C1-C7 being symmetrically distributed with respect to the common column side surface C4.

As another example, as shown in FIG. 4(c), crystal units 201a-9 to 201a-15 are in the second column of a 7×8 (7 rows and 8 columns) crystal array. For each crystal unit of the crystal units 201a-9 to 201a-15, the row side surface located on the rear side of the crystal unit is called a first row side surface, and the row side surface located on the front side of the crystal unit is called the second row side surface. The second row side surface of crystal unit 201a-9 and the first row side surface of crystal unit 201a-15 are the edge row side surfaces. The first row side surface of crystal unit 201a-1 and the second row side surface of crystal unit 201a-2 are regarded as the same row side surface, and are referred to as common row side surface C8; the second row side surface of crystal unit 201a-10 and the first row side surface of crystal unit 201a-11 are regarded as the same row side, and are referred to as common row side surface C9, and so on. The change in the optical conductivities of the at least two row side surfaces of the crystal units in the same column refers to the change in the optical conductivities of the at least two common row side surfaces (e.g., C8-C13, excluding the edge column sides) of the crystal units in the same column. For example, as shown in FIG. 4(c), along the column direction, the attached areas of the light guides on the common row side surfaces C8-C13 gradually decrease from both ends to the center, that is, the optical conductivities of at least two common row side surfaces C8-C13 gradually increase from both ends to the center. Further, the attached areas of the light guides on the common row side surfaces C8-C13 are symmetrically distributed with respect to the center of the column, leading to the optical conductivities of the at least two common row side surfaces C8-C13 being symmetrically distributed with respect to the center of the column.

In some embodiments of the present disclosure, by setting the variation of optical conductivity to occur only between different rows or different columns while maintaining consistency within the same row or the same column, the workload and complexity of calibrating each crystal unit can be reduced, thereby enabling batch processing and lowering manufacturing costs.

In some embodiments, the side surfaces of the at least two crystal units 201a have different optical control interfaces

The optical control interface refers to a functionalized area or structure on the crystal unit 201a that controls the propagation behavior of scintillation photons. The optical control interface may be capable of altering the propagation behavior of scintillation photons at the interface, such as controlling the proportion and direction of reflection, transmission, and scattering, thereby guiding or encoding the photon path.

In some embodiments, the side surfaces of the at least two crystal units 201a have different optical control interfaces can be achieved by at least one of: different material compositions of the side surfaces (e.g., integrated with a high-reflection film or a diffusely reflective coating with certain transmissivity), different physical thicknesses (where different thicknesses affect the optical conductivities of the side surfaces), different spatial patterns (e.g., different patterns such as stripes, dot arrays, grids), or different shapes (e.g., different shapes resulting in different areas of the side surfaces).

In some embodiments of the present disclosure, by providing different crystal units with side surfaces having different optical control interfaces, the propagation behavior of scintillation photons is actively and differentially controlled, so that the side surfaces of at least two of the plurality of crystal units have different optical conductivities as illustrated above, thereby achieving encoding and decoding of event location and depth within the entire crystal array.

In some embodiments, the optical control interface includes at least one of a reflective interface or an anti-reflective interface.

The reflective interface is an optical control interface capable of maximizing the reflection of photons. The reflective interface may efficiently reflect photons incident on the side surface of the crystal back into the interior of the crystal, preventing photons from escaping from the side surface, which is beneficial for directing photons towards the light emitting surface (bottom or top). In some embodiments, the larger the reflective interface, the lower the optical conductivity. In some embodiments, the reflective interface may be achieved by setting a reflective film or through reflective optical path design. For example, a reflective film may be adhered to the side surface of the crystal unit to form the reflective interface. As another example, an optical path may be designed on the side surface of the crystal unit. The design method of the optical path includes off-axis reflective optical system design, reflective optical path design in long focal length optical systems, and three-reflection optical system design, etc.

The anti-reflective interface is an optical control interface capable of maximizing the transmission of photons. The anti-reflective interface may reduce the reflection of photons at the side surface of the crystal, allowing photons to transmit through the interface into an adjacent crystal unit. In some embodiments, the larger the anti-reflective interface, the higher the optical conductivity. In some embodiments, the anti-reflective interface may be achieved by setting an anti-reflective film. For example, an anti-reflective film may be adhered to the side surface of the crystal unit to form the anti-reflective interface.

In some embodiments, a reflective zone (i.e., an area provided with the reflective interface) and an anti-reflective zone (i.e., an area provided with the anti-reflective interface) may be set in upper and lower partitions on the side surfaces of the crystal units 201a in the same row or the same column. For example, the first processing unit at the bottom needs to resolve position, so the anti-reflective zone may be set on the lower portion of the crystal units; and the second processing unit at the top only needs to collect energy, so the reflective zone may be set on the upper portion of the crystal units, achieving more precise light path control.

In some embodiments, the side surfaces of at least two of the plurality of crystal units 201a have different optical control interfaces, which may be achieved by adjusting the area and the position of the reflective interface and the anti-reflective interface. For example, when the optical control interfaces on the side surfaces of the at least two of the plurality of crystal units 201a are all reflective interfaces, an end of a reflective interface close to the first end of the crystal unit may be a fixed end. The area of the reflective interface may be changed by changing a distance between the second end of the crystal unit and an end of the reflective interface close to the second end of the crystal unit. That is, in the crystal units, the positions, along the z direction, of the ends of the reflective interfaces close to the first end of the crystal unit may be the same, and the positions, along the z direction, of the ends of the reflective interfaces close to the second end of the crystal unit may be different. As another example, when the optical control interfaces on the side surfaces of the at least two of the plurality of crystal units 201a are all anti-reflective interfaces, an end of the anti-reflective interface close to the second end of the crystal unit may be a fixed end. The area of the anti-reflective interface may be changed by changing a distance between the first end of the crystal unit and an end of the anti-reflective interface close to the first end of the crystal unit. That is, in the crystal units, the positions, along the z direction, of the ends of the anti-reflective interfaces close to the second end of the crystal unit may be the same, and the positions, along the z direction, of the ends of the anti-reflective interfaces close to the first end of the crystal unit may be different.

In some embodiments of the present disclosure, by using reflective interfaces and anti-reflective interfaces individually or in combination, the light output characteristics of each crystal unit can be precisely optimized, thereby achieving high-performance position resolution capability.

In some embodiments, the optical control interface includes at least one of a surface microstructure or an optical film.

The surface microstructure refers to a microscopic structure with specific geometric shapes and dimensions on the side surface of the crystal unit 201a. The surface microstructure may include a roughened structure, a micro-textured structure, etc. For example, the roughened structure may be obtained by physically or chemically roughening the side surface through manners such as grinding or etching to form random micron or nano-scale concave-convex structures. As another example, the side surface may be micro-textured to form a microscopic structure with a regular pattern, obtaining the micro-textured structure.

The optical film may include a reflective film, an anti-reflective film, or the like. The optical film may be a thin layer with specific optical functions (e.g., reflection or transmission) attached to the side surface of the crystal unit, thereby achieving reflection or transmission of photons.

In some embodiments, the side surfaces of at least two of the plurality of crystal units 201a have different optical control interfaces, which may be achieved by adjusting the area and the position of the optical film. For example, when the optical control interfaces on the side surfaces of the at least two of the plurality of crystal units 201a are all reflective films, an end of the reflective film close to the first end of the crystal unit may be a fixed end. The area of the reflective film may be changed by changing a distance between the second end of the crystal unit and an end of the reflective film close to the second end of the crystal unit. That is, in the crystal units, the positions, along the z direction, of the ends of the reflective films close to the first end of the crystal unit may be the same, and the positions, along the z direction, of the ends of the reflective films close to the second end of the crystal unit may be different. As another example, when the optical control interfaces on the side surfaces of the at least two of the plurality of crystal units 201a are all anti-reflective films, an end of the anti-reflective films close to the second end of the crystal unit may be a fixed end. The area of the anti-reflective film may be changed by changing a distance between the first end of the crystal unit and an end of the anti-reflective film close to the first end of the crystal unit. That is, in the crystal units, the positions, along the z direction, of the ends of the anti-reflective films close to the second end of the crystal unit may be the same, and the positions, along the z direction, of the ends of the anti-reflective films close to the first end of the crystal unit may be different.

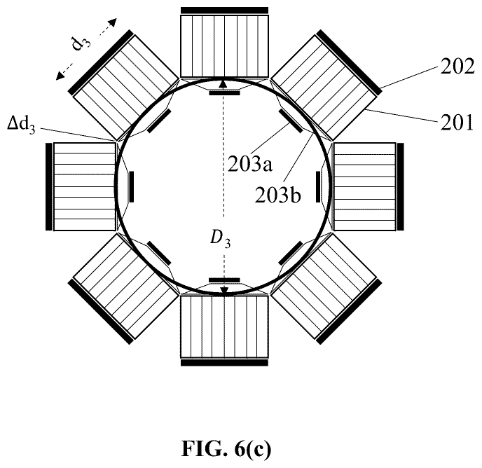

FIGS. 6(a)-6(c) are schematic comparison diagrams of exemplary detection rings according to some embodiments of the present disclosure. FIG. 6(a) shows a detection ring formed by splicing detectors 100 shown in FIG. 1, and FIG. 6(b) and FIG. 6(c) show a detection ring formed by splicing detectors 200 based on embodiments of the present disclosure.

In FIG. 6(b), there is no light guide disposed between the first processing unit and the crystal array, and between the second processing unit and the crystal array. In this case, the first processing unit 202 of the PET detector 200 is located on an inner ring, and the second processing unit 203 is located on an outer ring, or the second processing unit 202 of the PET detector 200 is located on an inner ring, and the first processing unit 203 is located on an outer ring.

When the first processing unit 202 is located on the inner ring and the second processing unit 203 is located on the outer ring, there is no limitation on whether the second processing unit 203 includes the light guide 203b or on a shape of the light guide 203b. When a modular splicing of the PET detector 200 is performed, the light guide 203b is located on an outer side of a detection ring, and does not increase the splicing dead zone.

In FIG. 6(c), the first processing unit 202 of the PET detector 200 is located on an outer ring, and the second processing unit 203 is located on an inner ring with the wedge-shaped light guide 203b disposed between the second processing unit and the crystal array. When a modular splicing of the dual-ended readout PET detector 200 is performed, due to the wedge shape of the light guide 203b, the light guide 203b does not increase the splicing dead zone.

The sensitivity n of the detection ring may be determined according to the following formula (1),

$$η = 100 \times \frac{{ε}^{2} \times φ \times Ω}{4 π} , \qquad ( 1 )$$

In formula (1), the detection efficiency ε is (1−e^{-μL})×Φ, where μ is the ray stopping power of the crystal units in the detection ring, L is the length of the crystal units along the extending direction of the crystal units, and Φ is the detector energy window setting.

Packing fraction is

$$φ = \frac{d}{d + Δ d} ,$$

where d is the effective width (e.g., along the x or y direction) of a detector in a detection ring, and Δd is a splicing dead zone between detectors.

Solid angle is Ω=4π sin[tan⁻¹(A/D)], where A is the axial length of the detection ring, and D is a circumferential diameter of the detection ring.

Combining FIG. 6(a), FIG. 6(b), FIG. 6(c), and the above formula (1), it can be seen that, given the width d₁ of the detector 100 is the same as the width d₂ of the detector in FIG. 6(b) and the width d₃ of the detector in FIG. 6(c), if the detectors are modularly spliced to form a detection ring (e.g., the axial direction of the crystal units is along the radial direction of the detection ring), the detection efficiency, the effective width d of the detection unit, and the axial length A of the detection ring remain unchanged between FIG. 6(a), FIG. 6(b), and FIG. 6(c). Since the detector 100 in the related art includes the light guide layer 102 and the light guide layer 104, a splicing dead zone Δd₁ of the detection ring in FIG. 6(a) is greater than a splicing dead zone Δd₂ of the detection ring in FIG. 6(b) and a splicing dead zone Δd₃ of the detection ring in FIG. 6(c). A circumferential diameter D₁ of the detection ring in FIG. 6(a) is greater than a circumferential diameter D₂ of the detection ring in FIG. 6(b) and a circumferential diameter D₃ of the detection ring in FIG. 6(c). It should be seen that the cuboid light guide increases the splicing dead zone and the solid angle, thereby reducing the sensitivity n. Therefore, a system sensitivity of the detection ring formed by the detector provided in the present disclosure is higher.

In one embodiment, the crystal array includes 8×8 crystal units, and a crystal unit of 0.8 mm×0.8 mm (millimeter) may be used as an example. The light-splitting structure disposed on the side surfaces of the crystal units is ESR; the first processing unit includes a 2×2 array including 3 mm×3 mm silicon photomultipliers (SiPMs) (the first photoelectric components), and the second processing unit includes a single 6 mm×6 mm silicon photomultiplier (SiPM) (the second photoelectric component). In some embodiments, the first photoelectric component and the second photoelectric component are read out by corresponding Application Specific Integrated Circuits (ASICs), respectively. Based on a small animal detection system including the above detector, responses of rays in each crystal unit of the crystal array can be clearly distinguished. An average DOI resolution is 1.96 mm. An average energy resolution after calibration under 511 keV (kilo electron volt) gamma energy is 13.1%. An average time resolution is 266 ps (picosecond). The overall performance is excellent.

Some embodiments of the present disclosure further provide a positron emission tomography (PET) imaging device. The PET imaging device includes a plurality of dual-ended readout PET detectors. Continuing to refer to FIG. 2-FIG. 5(a), and FIG. 5(b), each dual-ended readout PET detector 200 includes the crystal array 201, the first processing unit 202, and the second processing unit 203. The crystal array 201 includes a plurality of crystal units 201a. The first processing unit 202 is disposed at a first end of the crystal array 201. The second processing unit 203 is disposed at a second end of the crystal array 201, and the first end and the second end are disposed opposite to each other. Each of the plurality of crystal units includes a side surface between the first end and the second end, and the side surfaces of at least two of the plurality of crystal units have different optical conductivities. The plurality of dual-ended readout PET detectors 200 are arranged around a same axis to form a detection ring, and along a radial direction of the detection ring, the first processing unit of each of the dual-ended readout PET detectors is closer to the axis than the second processing units of the plurality of dual-ended readout PET detectors.

In some embodiments, the extending direction of the crystal units corresponds to the radial direction of the detection ring, one of the row direction of the crystal array and the column direction of the crystal array corresponds to the axial direction of the detection ring, and the other of the row direction of the crystal array and the column direction of the crystal array corresponds to the axial direction of the detection ring is along the circumferential direction of the detection ring.

In some embodiments, along a circumference of the detection ring, a difference between a second minimum distance (e.g., the splicing dead zone Δd₂ in FIG. 6(b) between crystal arrays 201 in adjacent dual-ended readout PET detectors 200, and a first minimum distance between the second photoelectric components in the adjacent dual-ended readout PET detectors 200 is within a preset range.

The second minimum distance between the crystal arrays 201 in the adjacent dual-ended readout PET detectors 200 may be a spacing between lower edges of two adjacent crystal arrays 201 along the circumference of the detection ring. The first minimum distance between the adjacent dual-ended readout PET detectors 200 may be a spacing between housings of two adjacent dual-ended readout PET detectors 200 along the circumference of the detection ring.

The preset range may be a system default value, an empirical value, a manually preset value, or any combination thereof. The preset range may be set according to actual requirements. The present disclosure does not limit this.

In some embodiments, along the circumference of the detection ring, the second minimum distance between the crystal arrays 201 in the adjacent dual-ended readout PET detectors 200 is smaller than the first minimum distance between the adjacent dual-ended readout PET detectors.

In some embodiments, along the circumference of the detection ring, the second minimum distance between the crystal arrays 201 in the adjacent dual-ended readout PET detectors 200 is equal to the first minimum distance between the adjacent dual-ended readout PET detectors.

In some embodiments, in the detection ring, along the radial direction of the detection ring, the second processing units of the plurality of dual-ended readout PET detectors are closer to the axis than the first processing units of the plurality of dual-ended readout PET detectors. The first processing units is directly coupled to the crystal array without light guide between the first processing units and the crystal array. Because the thickness the first processing units (e.g., the first photoelectric components) is very small and can be ignored, along the circumference of the detection ring, the second minimum distance between the crystal arrays 201 in the adjacent dual-ended readout PET detectors 200 can be regarded as being equal to the first minimum distance between the second photoelectric components in the adjacent dual-ended readout PET detectors 200.

In some embodiments, even though there is a light guide between the second processing unit and the crystal array, the second processing unit and the light guide are disposed at the outer side of the detection ring, thereby the light guide not increasing the splicing dead zone of the detection ring. This can greatly reduce or even eliminate splicing dead zones, and optimizes system sensitivity and spatial resolution.

As shown in FIG. 6(a) and FIG. 6(b), assuming that the width d₁ of the detector 100 is the same as the width d₂ of the detector 200, it can be seen that a first minimum distance between the adjacent PET detectors 100 in the detection ring in FIG. 6(a) is equal to the first minimum distance between the adjacent dual-ended readout PET detectors 200 in the detection ring in FIG. 6(b). However, due to the existence of the light guides between the crystal arrays and the first processing units located at the inner side of the detection ring, along the circumference of the detection ring, a second minimum distance Δd₁ (the splicing dead zone) between the crystal arrays in the adjacent PET detectors 100 is greater than a second minimum distance Δd₂ (the splicing dead zone) between the crystal arrays in the adjacent dual-ended readout PET detectors 200. As shown in FIG. 6(b), along the circumference of the detection ring, a second minimum distance between the crystal arrays 201 in the adjacent dual-ended readout PET detectors 200 may be regarded as being equal to the first minimum distance between the adjacent dual-ended readout PET detectors 200.

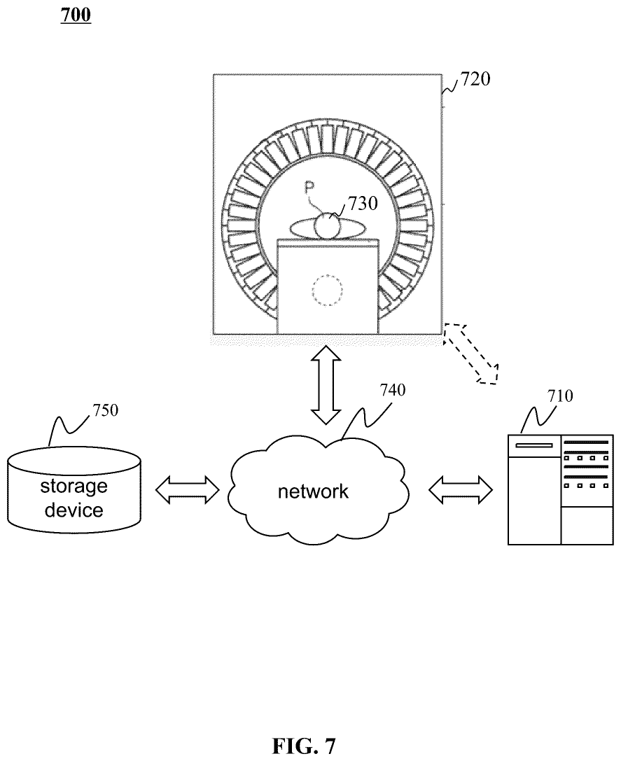

FIG. 7 is a schematic diagram illustrating an application scenario of an exemplary system for determining photon information according to some embodiments of the present disclosure. As shown in FIG. 7, an application scenario 700 of the system for determining photon information may include a processing device 710, an imaging device 720, a target object 730, a network 740, and a storage device 750.

In some embodiments, the processing device 710, the imaging device 720, the network 740, and the storage device 750 may be interconnected and/or communicate via a wireless connection, a wired connection, or a combination thereof. Connections between components of the system for determining photon information may be variable. For example, the imaging device 720 may be connected to the processing device 710 via the network 740 or directly. As another example, the storage device 750 may be connected to the processing device 710 via the network 740 or directly.

The processing device 710 may process data and/or information obtained from the imaging device 720 or the storage device 750. The processing device 710 may execute program instructions based on the data, the information, and/or a processing result to perform one or more functions described in the embodiments of the present disclosure. In some embodiments, the processing device 710 may include, but is not limited to, a central processing unit (CPU), a digital signal processor (DSP), a field-programmable gate array (FPGA), or other programmable logic devices. In some embodiments, the processing device 710 may also be a personal computer, a laptop computer, a server, or the like.

The imaging device 720 refers to a device that scans a target object through information acquisition to obtain information reflecting its internal state. In some embodiments, the imaging device 720 may include a positron emission tomography (PET) device. The PET device may include a detection ring for detecting gamma photons. The detection ring may include a plurality of dual-ended readout PET detectors 200 as illustrated above.

In some embodiments, the processing device 710 and/or the storage device 750 may be part of the imaging device 720.

In some embodiments, the imaging device 720 transmits photon information collected by the first processing unit and the second processing unit to the processing device 710 for processing via the network 740.

The target object 730 may include a biological object and/or a non-biological object. For example, the target object 730 may include a specific part of an object, e.g., the head, the chest, or the like. As another example, the target object 140 may be an object scanned by the imaging device 720.

The network 740 may include any suitable network that capable of facilitating information and/or data exchange. In some embodiments, one or more components (e.g., the processing device 710, the imaging device 720, and the storage device 750) of the system for determining photon information may be connected to and/or communicate with other components of the system for determining photon information via the network 740. For example, the processing device 710 may obtain the photon information from the imaging device 720 via the network 740. As another example, the processing device 710 may obtain computer instructions from the storage device 750 via the network 740.

In some embodiments, the network 740 may be any one or more of a wired network or a wireless network. For example, the network 740 may include a cable network, a fiber optic network, a telecommunication network, the Internet, a local area network (LAN), a wide area network (WAN), a wireless local area network (WLAN), a metropolitan area network (MAN), a public switched telephone network (PSTN), a Bluetooth network, a ZigBee network, near field communication (NFC), an in-device bus, an in-device line, a cable connection, or the like, or any combination thereof.

The storage device 750 may store data, instructions, and/or any other information. In some embodiments, the storage device 750 may store data obtained from the processing device 710 or the imaging device 720. In some embodiments, the storage device 750 may store data and/or instructions for the processing device 710 to execute or use to complete the exemplary methods described in the present disclosure.

In some embodiments, the storage device 750 may be used to store computer instructions or a computer program. For example, software programs of application software and modules, such as a computer program corresponding to the method for determining photon information in the embodiments of the present disclosure. The processing device 710 executes various functional applications and data processing, i.e., implements the method for determining photon information described in the embodiments of the present disclosure, by running computer instructions or computer programs stored in the storage device 750. The storage device 750 may include high-speed random access memory, removable memory, volatile read-write memory, non-volatile memory, or any combination thereof. In some instances, the storage device 750 may further include memory remotely located relative to the processing device 710. The remote memory may be connected to the terminal via a network. Examples of the network include, but are not limited to, the Internet, an intranet, a local area network, a mobile communication network, or any combination thereof. In some embodiments, the storage device 750 may be implemented on a cloud platform. In some embodiments, the storage device 750 may be part of the processing device 710.

It should be noted that the application scenario 700 of the system for determining photon information is provided merely for illustrative purposes and is not intended to limit the scope of the present disclosure. For those of ordinary skill in the art, various modifications or variations can be made based on the description of the present disclosure. However, the variations and modifications do not depart from the scope of the present disclosure.

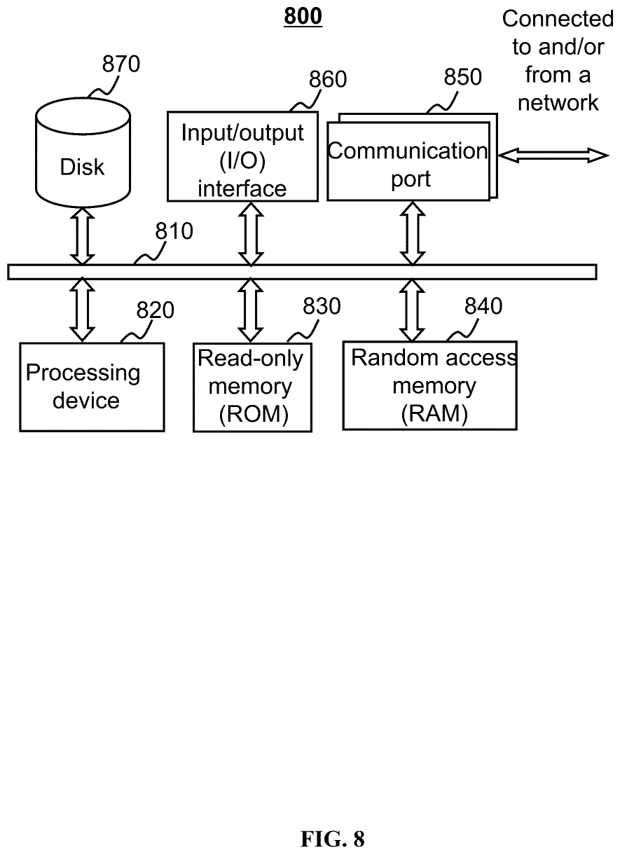

FIG. 8 is a schematic diagram illustrating an exemplary structure of a computer device according to some embodiments of the present disclosure. The computer device 800 may be configured to perform one or more functions of various modules in the system for determining photon information disclosed in the embodiments of the present disclosure.

The computer device 800 may be a general-purpose computer or a special-purpose computer, both of which may be used to implement the system for determining photon information of the present disclosure. The computer device 800 may be used to implement any component of the system for determining photon information as described in the present disclosure. For example, the processing device may be implemented on the computer device 800 via its hardware, software program, firmware, or a combination thereof. For convenience, only one computer is shown in the figure. However, the computer functions related to the optimization of medical images described in the present disclosure may be implemented in a distributed manner on a plurality of similar platforms to distribute the processing load.

In some embodiments, the computer device 800 may include a communication port 850 connected to and/or from a network for data communication. The computer device 800 may further include a processing device 820 in the form of one or more processors for executing program instructions. An exemplary computer platform may include an internal communication bus 810, program memory and data memory of different types (e.g., a disk 870, a read-only memory (ROM) 830, or a random access memory (RAM) 840), and various data files processed and/or transmitted by the computer. The exemplary computer platform further includes program instructions stored in the ROM 830, the RAM 840, and/or other forms of non-transitory storage media for execution by the processing device 820. The methods and/or processes of the present disclosure may be implemented in the form of program instructions. The computer device 800 may further include an input/output (I/O) interface 860, which may support input/output between the computer and other components. The computer device 800 may also receive programming and data via network communication.

Merely for illustration, only one CPU and/or processing device is exemplarily described in the computer device 800. However, it should be noted that the computer device 800 in the present disclosure may include a plurality of CPUs and/or processing devices. Therefore, operations and/or methods described herein as being implemented by one CPU and/or processing device may also be implemented jointly or independently by the plurality of CPUs and/or processing devices. For example, if in the present disclosure, a CPU and/or processing device of the computer device 800 performs operation A and operation B, it should be understood that operation A and operation B may also be performed jointly or independently by two different CPUs and/or processing devices in the computer device 800 (e.g., a first processing device performs operation A, a second processing device performs operation B, or the first and second processing devices jointly perform operations A and B).

FIG. 9 is a flowchart of an exemplary process for determining photon information according to some embodiments of the present disclosure. As shown in FIG. 9, the process 900 includes operation 910 to operation 930.

In some embodiments, the process 900 may be executed by the processing device. The processing device is configured to determine, based on photon information collected by the first processing unit, first energy information and 2D position information of scintillation photons emitted from the first end, and to determine, based on photon information collected by the second processing unit, second energy information of scintillation photons emitted from the second end.

In some embodiments, the method for determining photon information is implemented on a dual-ended readout PET detector. The dual-ended readout PET detector includes the crystal array, the first processing unit disposed at the first end of the crystal array, and the second processing unit disposed at the second end of the crystal array. The method including: determining, based on first photon information of first scintillation photons that are emitted from the first end and collected by the first processing unit, first energy information of the first scintillation photons and 2D position information; determining, based on second photon information of second scintillation photons that are emitted from the second end and collected by the second processing unit, second energy information of the second scintillation photons; and determining response depth information based on the first energy information and the second energy information.

For more content regarding the dual-ended readout PET detector, refer to FIG. 2-5 and related descriptions.

In 910, the first energy information of the first scintillation photons and the 2D position information may be determined based on the first photon information of the first scintillation photons that are emitted from the first end and collected by the first processing unit.

The photon information refers to physical parameters related to scintillation photons obtained through signal processing and analysis after the dual-ended readout PET detector receives the scintillation photons. In some embodiments, the photon information may include energy information of scintillation photons, quantity information of scintillation photons, and the like.

In this embodiment, the photon information collected by the first processing unit may represent an energy distribution of scintillation photons received by the first processing unit. For example, the photon information may include an energy of scintillation photons detected by each first photoelectric component in the first processing unit. Then, the processing device may determine the 2D position information according to the photon information collected by the first processing unit. In other words, the processing device is configured to determine 2D coordinates, in the x-y coordinate plane, of a position where scintillation photons are generated in response to a gamma photon.

In some embodiments, the processing device is configured to process and analyze scintillation photons collected by each first photoelectric component to obtain the photon information.

The first energy information refers to energy data related to all scintillation photons collected by the first processing unit. The photon energy is used to locate response distribution information of a gamma photon.

In some embodiments, the count of the scintillation photons is proportional to the scintillation photon energy. For each first photoelectric component, the processing device may obtain the count of scintillation photons received by the first photoelectric component. The processing device may determine photon energy by querying a preset energy comparison table based on the count of the scintillation photons included in the photon information. The preset energy comparison table may include photon energies corresponding to different counts of scintillation photons. The preset energy comparison table may be predetermined based on prior knowledge or historical data.

In some embodiments, the plurality of first photoelectric components of the first processing unit may detect scintillation photons emitted from the first end of the crystal array. The processing device sums the photon energies collected by each first photoelectric component to serve as the first energy information of the scintillation photons emitted from the first end.

As an example, the processing device may determine the first energy information by formula (2):

$${E}_{s u m 1} = {\sum }_{i = 1}^{M} {\sum }_{j = 1}^{N} E ( i , j ) , \qquad ( 2 )$$

wherein Eₛᵤₘ₁ is the first energy information representing a sum of the photon energies collected by all first photoelectric components; E(i, j) represents the photon energy collected by the first photoelectric component in an i-th row and a j-th column.

The 2D position information is information for locating a response position of a gamma photon. The response position refers to two-dimensional position coordinates on a detector plane (e.g., x-y plane) where the gamma photon interacts with the crystal array 201. The 2D position information may be represented in various ways. For example, the 2D position information may use Cartesian coordinates (x, y) on a two-dimensional plane to represent position information of an incident point of a gamma photon. As another example, the 2D position information uses pixel indices (i, j) of the crystal array to represent position information of an incident point of a gamma photon, wherein i and j represent a row sequence number and a column sequence number of a crystal unit, respectively.

In some embodiments, the processing device may determine 2D position information in various ways. For example, the processing device may determine the 2D position information using an energy center of gravity manner, a maximum likelihood manner, etc.

In some embodiments, the processing device may determine the 2D position information using a trained position determination model.

The position determination model refers to a model used to determine the 2D position information. In some embodiments, the position determination model may be a machine learning model. For example, the position determination model includes one or a combination of a Convolutional Neural Network (CNN) model, other custom models, etc.

In some embodiments, an input of the position determination model may include the photon information collected by the first processing unit, and an output of the position determination model may be the 2D position information.

In some embodiments, the position determination model may be obtained by training with a large count of first training samples having first training labels. The first training sample may include sample photon information. The first label may be 2D position information corresponding to the first training sample. In some embodiments, the first training samples and the first labels may be obtained based on historical data.

In some embodiments, the model may be trained using various ways based on the first training samples and the first labels. For example, training may be performed based on a gradient descent manner. Merely by way of example, a plurality of first training samples with first labels may be input into an initial position determination model. A loss function is constructed based on the first labels and a result of the initial position determination model.

Parameters of the initial position determination model are iteratively updated based on the loss function. Training of the model is completed when the loss function of the initial position determination model satisfies a preset condition, resulting in a trained position determination model. The preset condition may be convergence of the loss function, a count of iterations reaching a threshold, etc.

In some embodiments, the processing device may determine a plurality of first target positions. For each first target position, the processing device may determine a first energy for the first target position based on a sum of photon energies detected by the first photoelectric components located at the first target position. The processing device may determine a second energy based on the first energy of each first target position. The processing device may determine a first position coordinate of the 2D position information in a first preset direction based on the second energy of the first target positions and the photon energies detected by the first photoelectric components of the first processing unit. The first preset direction is perpendicular to a direction in which the first target position is located.

In some embodiments, the processing device may determine a plurality of second target positions. For each second target position, the processing device may determine a first energy for the second target position based on a sum of photon energies detected by the first photoelectric components located at the second target position. The processing device may determine a second energy based on the first energy of each second target position. The processing device may determine a second position coordinate of the 2D position information in a second preset direction based on the second energy of the second target positions and the photon energies detected by the first photoelectric components of the first processing unit. The second preset direction is perpendicular to a direction in which the second target position is located. The first position coordinate and the second position coordinate form the 2D position information.

In some embodiments, the first target position refers to a row of first photoelectric components, and the second target position refers to a column of first photoelectric components. For the second target position of a column of first photoelectric components, the processing device may sum the photon energies detected by the column of first photoelectric components to obtain a corresponding first energy

$${\sum }_{i = 1}^{M} {E}_{( i , j )} .$$

For the first target position of a row of first photoelectric components, the processing device may sum the photon energies detected by the row of first photoelectric components to obtain a corresponding first energy

$${\sum }_{j = 1}^{N} {E}_{( i , j )} .$$

In this embodiment, the processing device may determine the first position coordinate in the first preset direction according to a quotient between the second energy corresponding to the first target positions and the first energy information Eₛᵤₘ₁. The processing device may determine the second position coordinate in the second preset direction according to a quotient between the second energy corresponding to the second target positions and the first energy information Eₛᵤₘ₁. As shown in FIG. 3, an x direction is defined as a row direction, and a y direction is defined as a column direction. The x direction and the y direction are perpendicular to each other. If the second target position is a column of first photoelectric components, the direction in which the second target position is located is the column direction, and the second preset direction is the row direction. If the first target position is a row of first photoelectric components, the direction in which the first target position is located is the row direction, and the first preset direction is the column direction.

In the above embodiments, because the photon information collected by the processing device includes the photon energies detected by the first photoelectric components, the first energy may be determined based on the sum of the photon energies detected by the first photoelectric components located at the first and the second target positions. Then, the second energy may be determined based on the first energy corresponding to each target position. Finally, the first position coordinate in the first preset direction and the second position coordinate in the second preset direction of the 2D position information may be determined based on the second energy and the photon energies detected by the first photoelectric components. In some embodiments, because the target position is in a same row or a same column, and the preset direction is perpendicular to the direction in which the target position is located, the first and the second position coordinates may be determined efficiently and accurately based on the photon information collected by the first processing unit.

Details regarding determining the second energy can be found in the description below.

In some embodiments, the crystal array includes the plurality of crystal units. The first end and the second end are arranged opposite to each other. Each crystal unit includes a side surface located between the first end and the second end. The processing device includes a plurality of first photoelectric components arranged into a plurality of photoelectric component rows and a plurality of photoelectric component columns. Correspondingly, determining the 2D position information based on first photon information of first scintillation photons that are emitted from the first end and collected by the processing device includes: determining a row weight and a column weight corresponding to each of the plurality of first photoelectric components based on optical conductivities of the side surfaces of the plurality of crystal units; for each row of first photoelectric components (e.g., the first target position), determining a row energy based on the first photon information and the row weights of the plurality of first photoelectric components; for each column of first photoelectric components (e.g., the second target position), determining a column energy based on the first photon information and the column weights of the plurality of first photoelectric components; and determining the 2D position information based on the row energy, the column energy, and the first energy information.

The row weight refers to a characteristic of light distribution of a photon signal along a row direction on a side surface of a crystal unit. A column weight refers to a characteristic of light distribution of a photon signal along a column direction on a side surface of a crystal unit.

In some embodiments, the processing device may determine the row weight and the column weight corresponding to each first photoelectric component based on an optical conductivity of the side surface of the crystal unit through various ways. For example, the processing device may determine the row weight and the column weight corresponding to each first photoelectric component through experimental calibration. As another example, the processing device may allocate the row weight and the column weight corresponding to each first photoelectric component based on a gradient change of the optical conductivity of the side surface of the crystal unit or a photon signal intensity. Merely by way of example, for a first photoelectric component S1 and a first photoelectric component S2, if the crystal units covered by the first photoelectric component S1 are with a greater change in the optical conductivities of the side surfaces, a greater row weight and a greater column weight are allocated to the first photoelectric component S1. Accordingly, the crystal units covered by the first photoelectric component S2 are with a slight change in the optical conductivities of the side surfaces, a smaller row weight and a smaller column weight are allocated to the first photoelectric component S2.

As another example, the processing device may determine the row weight and the column weight corresponding to each first photoelectric component based on the first and the second target positions. The row weight and the column weight corresponding to a first photoelectric component may be determined by a row number of the photoelectric component row (e.g., the first target position) and a column number of the photoelectric component column (e.g., the second target position) where the first photoelectric component is located. For example, the row weight of a first photoelectric component may be the row number of the photoelectric component row where the first photoelectric component is located minus 1 (e.g., the weight of i−1 in formula (5)). The column weight of a first photoelectric component may be the column number of the photoelectric component column where the first photoelectric component is located minus 1 (e.g., the weight of j−1 in formula (6)). Merely by way of example, when the first photoelectric component is located in the first photoelectric component row and the first photoelectric component column, the corresponding row weight and column weight are 0, respectively. When the first photoelectric component is located in the second photoelectric component row and the second photoelectric component column, the corresponding row weight and column weight are 1, respectively, and so on. This embodiment can be understood in combination with formula (5) and formula (6).

The row energy refers to a sum of photon energies collected by each first photoelectric component in a certain row after adjustment by a row weight. The column energy refers to a sum of photon energies collected by each first photoelectric component in a certain column after adjustment by a column weight.

Photon energy detected by a first photoelectric component 202a is E(i, j), wherein i represents a row number, with a value ranging from 1 to M (as shown in FIG. 3 or FIG. 5(a)), and j represents a column number, with a value ranging from 1 to N (as shown in FIG. 3 or FIG. 5(a)). M and N are both integers greater than 1.

Taking a first target position of an i-th photoelectric component row as an example, the processing device may multiply the photon energy collected by each first photoelectric component in the i-th row by a corresponding row weight, and then sum the products corresponding to the first photoelectric components in the i-th photoelectric component row to obtain a row energy of the i-th photoelectric component row. For example, the processing device may determine a row energy of an i-th row by formula (3):

$${E}_{r o w} ( i ) = {\sum }_{j = 1}^{N} [ E ( i , j ) \times {W}_{r o w} ( i , j ) ] , \qquad ( 3 )$$

where E(i,j) represents a photon energy collected by a first photoelectric component in an i-th photoelectric component row and a j-th photoelectric component column, and W_{row}(i, j) represents a row weight of the first photoelectric component in the i-th row and the j-th column.

Taking a second target position of a j-th column as an example, the processing device may multiply the photon energy collected by each first photoelectric component in the j-th column by a corresponding column weight, and then sum the products corresponding to the first photoelectric components in the j-th photoelectric component column to obtain a column energy of the j-th column. For example, the processing device may determine a column energy of a j-th column by formula (4):

$${E}_{c o l} ( j ) = {\sum }_{i = 1}^{M} [ E ( i , j ) \times {W}_{c o l} ( i , j ) ] , \qquad ( 4 )$$

where W_{col}(i, j) represents a column weight of the first photoelectric component in the i-th row and the j-th column.

When the row weights corresponding to the first photoelectric components in the same photoelectric component row are the same, a product of the first energy corresponding to the photoelectric component row and the row weight can be determined as the row energy of the photoelectric component row. When the column weights corresponding to the first photoelectric components in the same photoelectric component column are the same, a product of the first energy corresponding to the photoelectric component column and the column weight can be determined as the column energy of the photoelectric component column.

Taking a first target position of an i-th photoelectric component row as an example, the processing device may multiply the first energy of the i-th row by a corresponding row weight to obtain a row energy of the i-th photoelectric component row. For example, the processing device may determine a row energy of an i-th row by formula (5):

$${E}_{r o w} ( i ) = ( i - 1 ) \times {\sum }_{j = 1}^{N} {E}_{( i , j )} . \qquad ( 5 )$$

Taking a second target position of a j-th column as an example, the processing device may multiply the first energy of the j-th column by a corresponding column weight to obtain a column energy of the j-th column. For example, the processing device may determine a column energy of a j-th column by formula (6):

$${E}_{c o l} ( j ) = ( j - 1 ) \times {\sum }_{i = 1}^{M} {E}_{( i , j )} . \qquad ( 6 )$$

In some embodiments, the processing device may determine the first position coordinate in a column direction based on the row energy and the first energy information. The processing device may determine the second position coordinate a row direction based on the column energy and the first energy information. In some embodiments, the second energy of photoelectric component rows may be determined based on a sum of the row energies of multiple photoelectric component rows. The first position coordinate in the column direction can be determined based on a ratio of the second energy of the multiple photoelectric component rows to the first energy information. The second energy of photoelectric component columns may be determined based on a sum of the column energies of multiple photoelectric component columns, and the second position coordinate in the row direction may be determined based on a ratio of the second energy of photoelectric component column to the first energy information.

For example, the processing device may determine the first position coordinate in the column direction by formula (7):

$$Y = \frac{{\sum }_{i = 1}^{M} {E}_{r o w} ( i )}{{E}_{s u m 1}} , \qquad ( 7 )$$

where E_{row}(i) is a row energy of an i-th row.

For example, the processing device may determine the second position coordinate in the row direction by formula (8):

$$X = \frac{{\sum }_{j = 1}^{N} {E}_{c o l} ( j )}{{E}_{s u m 1}} , \qquad ( 8 )$$

where E_{col}(j) is a column energy of a j-th column. In some embodiments of the present disclosure, by introducing the row weight and the column weight and performing weight distribution based on a characteristic of lateral optical conductivity of the crystal units, 2D position information of a gamma photon event can be reconstructed more accurately.

In 920, the second energy information of second scintillation photons is determined based on the second photon information of the second scintillation photons that are emitted from the second end and collected by the second processing unit.

In this embodiment, a principle of the photon information collected by the second processing unit is the same as that of the photon information collected by the first processing unit. Details are not repeated herein.

The second energy information refers to energy data related to all scintillation photons collected by the second processing unit.

In some embodiments, the at least one second photoelectric component of the second processing unit may detect scintillation photons emitted from the second end of the crystal. The processing device sums photon energies collected by each second photoelectric component and uses the sum as the second energy information of the scintillation photons emitted from the second end.

In 930, the response depth information is determined, by the processing device, based on the first energy information and the second energy information.

The response depth information refers to information about an interaction position of a gamma photon inside the crystal along a depth direction (the z direction in FIG. 2). In some embodiments, the processing device may reconstruct a three-dimensional position of a gamma photon event based on the response depth information and the 2D position information.

The processing device may determine the response depth information based on the first energy information and the second energy information through various ways.

In some embodiments, the processing device may determine the response depth information by querying a depth lookup table based on the first energy information and the second energy information. For example, the processing device may determine a depth of interaction (DOI) based on the first energy information and the second energy information, and determine the response depth information by querying the depth lookup table based on the DOI. The depth of interaction of the photon is DOI=Eₛᵤₘ₂/(Eₛᵤₘ₁+Eₛᵤₘ₂). Eₛᵤₘ₂ refers to the second energy information. The depth lookup table may include a correspondence between different DOIs and different response depth information. The depth lookup table may be predetermined based on prior knowledge or historical data.

In some embodiments, the processing device may determine the response depth information through a trained depth determination model based on the first energy information and the second energy information.

The depth determination model refers to a model used to determine response depth information. In some embodiments, the depth determination model may be a machine learning model. For example, the depth determination model includes one or a combination of a Convolutional Neural Network (CNN) model, or other custom models.

In some embodiments, an input of the depth determination model may include the first energy information and the second energy information, and an output may be the response depth information.

In some embodiments, the depth determination model may be obtained by training with a large count of second training samples with second training labels. The second training sample may include sample first energy information and sample second energy information. The second label may be response depth information of a photon corresponding to the second training sample. In some embodiments, the second training samples and the second labels may be obtained based on historical data.

A training process of the depth determination model is similar to a training process of a position determination model, which is not repeated here.

In some embodiments, the processing device may also determine a time of the gamma photon when the gamma photon interacts with the crystal array based on the photon information collected by the processing device and the photon information collected by the second processing unit. Merely by way of example, the processing device may also input the photon information collected by the first processing unit and the photon information collected by the second processing unit into a trained machine learning model, and the machine learning model outputs the time of the gamma photon.

In the above embodiments, using the aforementioned detector, 2D position information, response depth information, and a time of a gamma photon event response can be obtained efficiently, accurately, and with relatively low hardware cost.

In some embodiments of the present disclosure, by separately processing the photon information collected by the first processing unit and the second processing unit to determine energy information, the 2D position information, and the response depth information, the advantages of dual-end readout are fully utilized. The response depth information is effectively extracted through means such as an energy ratio method, thereby correcting a parallax effect in PET imaging. Since photons may be reflected to the first processing unit and the second processing unit, the response depth information can be determined efficiently and accurately based on the photon energy detected by all the second photoelectric components and an energy of scintillation photons detected by each first photoelectric component.

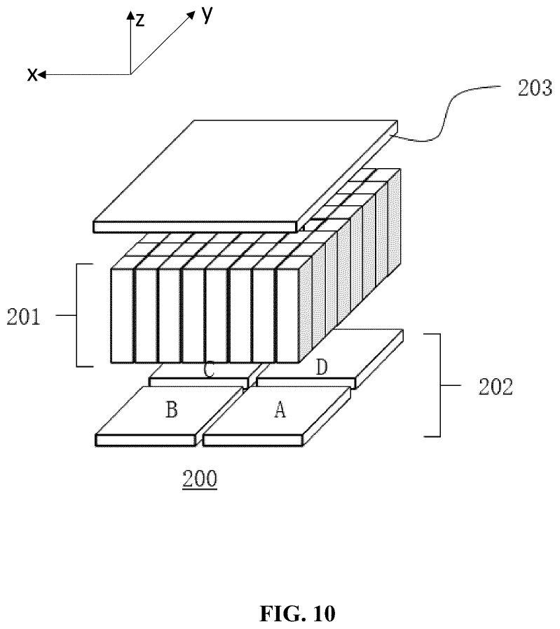

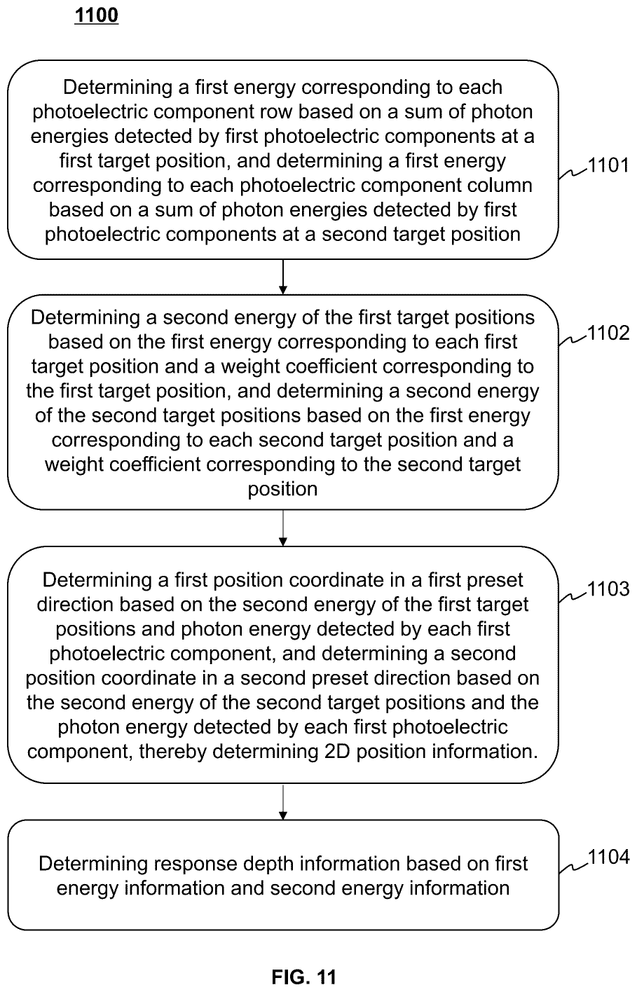

To more clearly introduce the method for determining photon information in the present disclosure, description is provided below in conjunction with FIG. 10 and FIG. 11. FIG. 10 is a schematic diagram illustrating a structure of an exemplary detector of a medical scanning device according to some other embodiments of the present disclosure. FIG. 10 illustrates a dual-ended asymmetric detector, including 2×2 first photoelectric components and 1 second photoelectric component. In FIG. 10, photon energies detected by the four first photoelectric components are denoted as A, B, C, and D, respectively, and A+B+C+D=Eₛᵤₘ₁. Photon energy detected by the second photoelectric component of the second processing unit 203 is denoted as Eₛᵤₘ₂.

FIG. 11 is a schematic diagram illustrating a process for determining photon information according to some embodiments of the present disclosure. A process 1100 includes operations 1101-1104.

In 1101, a first energy corresponding to each photoelectric component row (e.g., each first target position) is determined based on a sum of the photon energies detected by the first photoelectric components at the first target position, and a first energy corresponding to each photoelectric component column (e.g., each second target position) is determined based on a sum of the photon energies detected by the first photoelectric components at the second target position.

In 1102, a second energy of the first target positions is determined based on the first energy corresponding to each first target position and a weight coefficient (e.g., row weight) corresponding to the first target position, a second energy of the second target positions is determined based on the first energy corresponding to each second target position and a weight coefficient (e.g., column weight) corresponding to the second target position.

In 1103, a first position coordinate in a first preset direction (e.g., the column direction) is determined based on the second energy of the first target positions and the photon energy detected by each first photoelectric component, a second position coordinate in a second preset direction (e.g., the row direction) is determined based on the second energy of the second target positions and the photon energy detected by each first photoelectric component, thereby determining 2D position information.

For example, taking FIG. 10 as an example, by putting photon energies A, B, C, and D detected by the four first photoelectric components into formula (5) and formula (6), the second position coordinate in the row direction is

$$X = \frac{B + C}{A + B + C + D} ,$$

and the first position coordinate in the column direction is

$$Y = \frac{C + D}{A + B + C + D} .$$

Therefore, the 2D position information is (X, Y) on the x-y coordinate plane.

In 1104, the response depth information is determined based on the first energy information and the second energy information.

Taking FIG. 10 as an example,

$$DOI = \frac{{E}_{2}}{{E}_{1} + {E}_{2}} .$$

For the process of operations 1101-1104, reference may be made to the foregoing embodiments, and details are not described herein again.

The detector for a medical scanning device, the detection system, the method for determining photon information, and the PET imaging device provided in this embodiment have the following advantages:

First, the built-in light-splitting structure within the crystal array is formed by using the light-splitting structure disposed on the side surfaces to perform position encoding on the crystal array. This allows the crystal array to be directly coupled with the photoelectric component to obtain position information of the crystal array without the light guide layer. The first processing unit with more photoelectric components is disposed on the inner side of the detection ring. The second processing unit with a small count of or even a single photoelectric component is disposed on the outer side of the detection ring. This effectively reduces the impact of light-splitting material self-absorption and a plurality of interfaces on effective light collection. It also effectively reduces efficiency loss caused by splicing dead zones when forming the detection ring. System sensitivity and spatial resolution are optimized. Coupling process difficulty is reduced. Costs are lowered. Furthermore, photosensitive dead zones caused by large-scale splicing are reduced, improving signal quality and sensitivity.

Second, the count of photoelectric components used is reduced to

$$\frac{N \times M + 1}{2 ( N \times M )}$$

of a conventional dual-end readout circuit. Thus, cooperating with the crystal array with the built-in light-splitting structure, an asymmetric photoelectric readout scheme is adopted. This effectively reduces a readout channel density of electronics. Based on the dual-end structure, dual-end readout characteristics are retained, and hardware costs are further reduced.

Third, an ASIC may be used to lead out signals from each readout channel of the first photoelectric component and the second photoelectric component. This reduces a signal-to-noise ratio loss caused by using a resistor network. Meanwhile, signals from each channel are independently led out to preserve optimal time response characteristics.

Fourth, the detector structure is simple and has wide applicability. It can meet different needs by adjusting a size and a scale of the crystal array and the photoelectric readout device.

When operations performed are described step by step in the embodiments of the present disclosure, unless otherwise specified, an order of the operations is adjustable. Operations may be omitted. Other steps may also be included during the operation.

The description of the system and its modules in the embodiments of the present disclosure is for convenience of description only and cannot limit the scope of the embodiments. Various modules may be arbitrarily combined, or constitute subsystems connected to other modules, without departing from the principles of the system.

The embodiments in the present disclosure are for illustration and description only, and do not limit the applicable scope of the present disclosure. For those skilled in the art, various modifications and changes that can be made under the guidance of the present disclosure still fall within the scope of the present disclosure.

Certain features, structures, or characteristics in one or more embodiments of the present disclosure may be appropriately combined.

Aspects of the present disclosure may be executed entirely by hardware, entirely by software (including firmware, resident software, microcode, etc.), or by a combination of hardware and software. The above hardware or software may be referred to as a “data block”, “module”, “engine”, “unit”, “component”, “system”, or the like. Furthermore, aspects of the present disclosure may be embodied as a computer product located on one or more computer-readable media, the product including computer-readable program code.

A computer storage medium may be any computer-readable medium that can be connected to an instruction execution system, apparatus, or device to achieve communication, propagation, or transmission of a program for use. Program code located on the computer storage medium may be propagated via any suitable medium, including radio, cable, fiber optic cable, RF, or similar medium, or any combination of the foregoing media.

Computer program code required for operations of various parts of the present disclosure may be written in any one or more programming languages. The program code may execute entirely on a user's computer, execute as a standalone software package on the user's computer, execute partly on the user's computer and partly on a remote computer, or execute entirely on the remote computer or processing device. In the latter scenario, the remote computer may be connected to the user's computer through any type of network, such as a local area network (LAN) or a wide area network (WAN), or connected to an external computer (e.g., through the Internet), or in a cloud computing environment, or used as a service such as software as a service (SaaS).

Finally, it should be understood that the embodiments described in the present disclosure are merely used to illustrate the principles of the embodiments of the present disclosure. Other variations may also fall within the scope of the present disclosure. Therefore, merely by way of example and not limitation, alternative configurations of embodiments of the present disclosure may be considered consistent with the teachings of the present disclosure. Accordingly, the embodiments of the present disclosure are not limited to the embodiments explicitly introduced and described herein.

What is claimed is:

1. A dual-ended readout positron emission tomography (PET) detector, comprising a crystal array, a first processing unit, and a second processing unit, wherein:
the crystal array includes a plurality of crystal units;
the first processing unit is disposed at a first end of the crystal array;
the second processing unit is disposed at a second end of the crystal array, and the first end and the second end are disposed opposite to each other; and
each of the plurality of crystal units includes a side surface between the first end and the second end, the side surfaces of at least two of the plurality of crystal units have different optical conductivities.

2. The dual-ended readout PET detector of claim 1, wherein
the plurality of crystal units are arranged into multiple rows and multiple columns along a first direction and a second direction, the crystal units in each row are arranged along the first direction, and the crystal units in each column are arranged along the second direction;
the side surface of each of the crystal units includes a row side surface parallel to the first direction and a column side surface parallel to the second direction;
for at least one row of crystal units, the optical conductivities of at least two column side surfaces of the crystal units in the same row are different; and
for at least one column of crystal units, the optical conductivities of at least two row side surfaces of at least two crystal units in the same column are different.

3. The dual-ended readout PET detector of claim 2, wherein for the at least one row of crystal units, the optical conductivities of the at least two column side surfaces of the crystal units in the same row increase from both ends to a center of the row; and/or
for the at least one column of crystal units, the optical conductivities of the at least two row side surfaces of the crystal units in the same column increase from both ends to a center of the column.

4. The dual-ended readout PET detector of claim 2, wherein the optical conductivities of the row side surfaces of the crystal units in the same row are the same, and the optical conductivities of the column side surfaces of the crystal units in the same column are the same.

5. The dual-ended readout PET detector of claim 1, wherein:
the first processing unit is configured to collect scintillation photons emitted from the first end, and the scintillation photons emitted from the first end are used for determining two-dimensional (2D) position information and first energy information of the scintillation photons emitted from the first end; and
the second processing unit is configured to collect scintillation photons emitted from the second end, and the scintillation photons emitted from the second end are used for determining second energy information of the scintillation photons emitted from the second end.

6. The dual-ended readout PET detector of claim 1, wherein a configuration of the first processing unit is different from a configuration of the second processing unit.

7. The dual-ended readout PET detector of claim 1, wherein
the first processing unit includes a plurality of first photoelectric components, and the second processing unit includes one or more second photoelectric components;
the plurality of first photoelectric components completely cover the first end, and the one or more second photoelectric components at least partially cover the second end; and
a count of the one or more second photoelectric components is smaller than a count of the plurality of first photoelectric components.

8. The dual-ended readout PET detector of claim 1, wherein
the first processing unit includes a plurality of first photoelectric components, and the second processing unit includes one or more second photoelectric components; and
the one or more second photoelectric components partially cover the second end; and the second processing unit further includes a light guide configured to converge the scintillation photons emitted from the second end to the one or more second photoelectric components.

9. The dual-ended readout PET detector of claim 1, wherein
the second processing unit includes one or more second photoelectric components; and
the one or more second photoelectric components completely cover the second end, and a count of the one or more second photoelectric components is greater than a count of the plurality of first photoelectric components.

10. A positron emission tomography (PET) imaging device, comprising a plurality of dual-ended readout PET detectors each of which is the dual-ended readout PET detector of claim 1;
the plurality of dual-ended readout PET detector are arranged around an axis to form a detection ring, and along a radial direction of the detection ring, the second processing units of the plurality of dual-ended readout PET detectors are closer to the axis than the first processing units of the plurality of dual-ended readout PET detectors.

11. The PET imaging device of claim 10, wherein along a circumference of the detection ring, there is a first minimum distance between the second photoelectric components in adjacent dual-ended readout PET detectors; there is a second minimum distance between the crystal arrays in the adjacent dual-ended readout PET detectors; and a difference between the first minimum distance and the second minimum distance is within a preset range.

12. The PET imaging device of claim 11, wherein the second minimum distance is smaller than the first minimum distance.

13. A method for determining photon information, implemented on a dual-ended readout positron emission tomography (PET) detector, the dual-ended readout PET detector comprising a crystal array, a first processing unit disposed at a first end of the crystal array, and a second processing unit disposed at a second end of the crystal array, the method comprising:
determining, based on first photon information of first scintillation photons that are emitted from the first end and collected by the first processing unit, two-dimensional (2D) position information and first energy information of the first scintillation photons;
determining, based on second photon information of second scintillation photons that are emitted from the second end and collected by the second processing unit, second energy information of the second photons; and
determining response depth information based on the first energy information and the second energy information.

14. The method of claim 13, wherein:
the first processing unit includes a plurality of first photoelectric components arranged into a plurality of rows and a plurality of columns; and
the determining, based on first photon information of first scintillation photons that are emitted from the first end and collected by the first processing unit, 2D position information includes:
determining a row weight and a column weight corresponding to each of the plurality of first photoelectric components; and
determining the 2D position information based on the row weight, the column weight, and the first energy information.

15. A dual-ended readout positron emission tomography (PET) detector, comprising a crystal array, a first processing unit, and a second processing unit, wherein:
the crystal array includes a plurality of crystal units, the crystal array being configured to detect a gamma photon and produce scintillation photons;
the first processing unit is disposed at a first end of the crystal array;
the second processing unit is disposed at a second end of the crystal array, and the first end and the second end are disposed opposite to each other;
the first processing unit includes a plurality of first photoelectric components, and the second processing unit includes at least one second photoelectric component;
a count of the one or more second photoelectric components is smaller than a count of the plurality of first photoelectric components;
a side surface between the first end and the second end of each of the plurality of crystal units is provided with a light-splitting structure configured to guide the scintillation photons to the first processing unit and the second processing unit;
the first processing unit is configured to determine first photon information of first scintillation photons that are emitted from the first end and collected by the first processing unit, and the first photon information are used for determining two-dimensional (2D) position information of the scintillation photons; and
the second processing unit is configured to determine second photon information of second scintillation photons that are emitted from the second end and collected by the second processing unit, and the second photon information are used for determining response depth information of the scintillation photons.

16. The dual-ended readout PET detector of claim 15, wherein areas of the light-splitting structures provided on the side surfaces of at least two of the plurality of crystal units are different.

17. The dual-ended readout PET detector of claim 15, wherein materials of the light-splitting structures provided on the side surfaces of at least two of the plurality of crystal units are different.

18. The dual-ended readout PET detector of claim 15, wherein a projection of the one or more second photoelectric components on the second end along an axial direction of the crystal array is smaller than a projection of the plurality of first photoelectric components on the first end along the axial direction, and the axial direction is between the first end and the second end.

19. The dual-ended readout PET detector of claim 15, wherein a projection of the plurality of first photoelectric components on the first end along an axial direction of the crystal array completely covers the first end, and a projection of the one or more second photoelectric components on the second end along the axial direction at least partially covers the second end;
a count of the one or more second photoelectric components is smaller than a count of the plurality of first photoelectric components; and
the axial direction is between the first end and the second end.

20. The dual-ended readout PET detector of claim 15, wherein a projection of the one or more second photoelectric components on the second end along an axial direction of the crystal array partially covers the second end; the second processing unit further includes a light guide configured to converge the scintillation photons emitted from the second end to the one or more second photoelectric components; and the axial direction is between the first end and the second end.
